(19) United States
(12) Patent Application Publication
(10) Pub. No.: US 2016/0286800 A1
(43) Pub. Date: Oct. 6, 2016

(54) STABILIZED COMPOSITION OF AN OXIDIZER AND METAL IONS, METHOD AND USE FOR IMPROVING DISEASE CONTROL, AND KIT FOR PREPARING SAID COMPOSITION

(71) Applicant: AGRI-NÉO INC., Toronto (CA)

(72) Inventors: Fadi DAGHER, Laval (CA); Nicholas DILLON, Toronto (CA); Kenneth Sherman UNGAR, Scarborough (CA)

(73) Assignee: AGRI-NÉO INC., Toronto, ON (CA)

(21) Appl. No.: 15/023,187

(22) PCT Filed: Aug. 25, 2014
(86) PCT No.: PCT/CA2014/050815

§ 371 Date: Mar. 18, 2016

Related U.S. Application Data
(60) Provisional application No. 61/879,864, filed on Sep. 19, 2013.

(51) Int. Cl. A01N 37/16

(52) U.S. Cl. CPC A01N 37/16

(57) ABSTRACT

A stabilized oxidizer composition, and method and use for improving disinfection, sanitation and/or disease control, and kit for preparing said composition. A stabilized oxidizer composition and a method for improving the stability and/or efficiency of said oxidizer composition. A powdered composition for the preparation of such stabilized and/or more efficient oxidizer composition. A stabilized and/or more efficient oxidizer composition, and method for improving the stability and pesticidal activity of the oxidant when mixed with other pesticides. Uses and methods involving said stabilized and/or more efficient oxidizer composition, and a kit for the preparation of a stabilized and/or more efficient oxidizer composition, advantageously in order to obtain a more efficient control of pathogens in and on any kind of surfaces in general, preferably on surfaces of the tissues of a growing plant. Preferably, the oxidizer mentioned hereinabove may be peracetic acid, hydrogen peroxide, or a precursor thereof.

### FIELD OF THE INVENTION

The invention relates to a stabilized oxidizer composition, and method and use for improving disinfection, sanitation and/or disease control, and kit for preparing said composition. Also, the invention relates to a stabilized oxidizer composition and a method for improving the stability and/or efficiency of said oxidizer composition. The invention also relates to powdered composition for the preparation of such stabilized and/or more efficient oxidizer composition.

Also, the invention relates to a stabilized and/or more efficient oxidizer composition, and method for improving the stability and pesticidal activity of the oxidant when mixed with other pesticides, notably, algaecides, fungicides, herbicides, insecticides, miticides, molluscicides, nematicides and adjuvants, notably, clays, defoamers, fertilizers, spreaders, stickers, surfactants. Preferably, said method is for improving and maintaining the stability, resistance management and pesticidal activity of the oxidant when mixed with other chemicals. More preferably, other chemicals may comprise other pesticides, additives and/or adjuvants.

Also, the invention relates to uses and methods involving said stabilized and/or more efficient oxidizer composition, and a kit for the preparation of a stabilized and/or more efficient oxidizer composition, advantageously in order to obtain a more efficient control of pathogens in and on any kind of surfaces in general, preferably on surfaces of the tissues of a growing plant.

According to a preferred aspect, the oxidizer mentioned hereinabove may be peracetic acid, hydrogen peroxide, or a compound which is selected from the group consisting of compounds which are precursors of chlorine ions, bromine ions, or iodine ions, more preferably peracetic acid, or a precursor thereof.

Preferably, the peracetic composition may be obtained from a water soluble mixture or composition (especially a powdered composition) comprising a peracetic precursor system and optionally at least one systemic enhancer, which once admixed with water, allow the control of pathogens in and on surfaces in general, more preferably on the tissues of a growing plant.

### BACKGROUND OF THE INVENTION

Peracetic acid (also known as peracid) is a strong oxidizing agent which is known to have virucidal, bactericidal, fungicidal and algaecidal properties. Therefore, peracetic acid was patented in 1950 to treat fruits and vegetables to reduce spoilage from bacteria and fungi destined for processing (U.S. Pat. No. 2,512,640). Nowadays, peracetic acid (PAA) is commonly used in food processing and handling as a sanitizer for food contact surfaces and as a disinfectant for fruits, vegetables, meat and eggs. In the production of fruits and vegetables, peracetic aqueous solutions have been suggested to control pathogenic organisms on growing plants (U.S. Pat. No. 6,024,986; No. 6,165,483; and No. 6,238,685).

One of the problems associated with oxidizer such as liquid peracetic aqueous solutions is that they are corrosive, highly acidic and dangerously reactive. There is thus a need for a mixture or a composition, preferably a powdered mixture, containing or capable of generating said oxidizer, such as for example peracetic acid, in situ in concentration and at a pH which when indented for an agricultural use, is safe for plants.

In WO2012/051699 the Applicant found a mixture or a composition, preferably a powdered mixture, containing or capable of generating peracetic acid in situ in concentration and at a pH which is safe for plants. More particularly, the Applicant had surprisingly discovered an unexpected synergistic activity between peracetic acid and at least one systemic enhancer for the control of pathogens in and on the tissues of a growing plant.

However, because peracetic acid decomposes rapidly, it has a very short useful life to treat pathogens on crops. Generally peracetic acid decomposes in few hours when sprayed on leaves and crops. Also, peracetic acid decomposes even faster if hardness and metal ions such as copper are present and are exposed to peracetic acid.

Consequently, there is a very strong need for an oxidizer composition having improved stability and/or efficiency over time, as well as a method for improving the stability and/or efficiency of said oxidizer compositions.

The Applicant has discovered that when an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof, is in the presence of a metal cation, preferably an agriculturally acceptable metal cation, and more preferably a metal cation comprising an element selected from the group consisting of Ag, Cu, Mn, Ti and Zn, and in the presence of an acid selected from the group consisting of inorganic acids and organic acids, preferably agriculturally acceptable inorganic acids and organic acids, the stability and/or the efficiency of said oxidizer is surprisingly improved. Also, the Applicant has discovered an unexpected synergistic activity between peracetic acid and at least one systemic enhancer for the control of pathogens in and on the tissues of a growing plant, as described in WO2012/051699.

### BRIEF SUMMARY OF THE INVENTION

An embodiment of the invention relates to a composition comprising:
an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof,
a compound defining a precursor of a metal cation, preferably a metal cation comprising an element selected from the group consisting of Ag, Cu, Mn, Ti and Zn;
an acid selected from the group consisting of inorganic acids and organic acids; and
optionally at least one excipient, additive and/or adjuvant;
   to stabilize said oxidizer for 1 to 48 hours at room temperature.

Another embodiment of the invention relates to a composition as defined hereinabove, wherein it comprises:
from 1 to 10000 ppm, preferably from 5 to 5000 ppm, of the oxidizer or the precursor thereof;
from 0.01 to 10 g/L, preferably from 0.1 g to 3 g/L of the compound defining the precursor of the metal cation comprising the element selected from the group consisting of Ag, Cu, Mn, Ti and Zn;
from 0.1 to 10 g/L of the acid selected from the group consisting of inorganic acids and organic acids;
   and wherein the at least one excipient includes water to thereby form an aqueous solution.

Another embodiment of the invention relates to a composition as defined hereinabove, wherein the oxidizer is peracetic acid or a precursor thereof.

Another embodiment of the invention relates to a composition as defined hereinabove, wherein the peracetic acid is liquid peracetic acid.

Another embodiment of the invention relates to a composition as defined hereinabove, wherein the peracetic acid is obtained by dissolving in water a powdered composition of 30-70% w/w of a solid hydrogen peroxide precursor, 5-40% w/w a pH adjusting agent, 5-40% w/w of an acetylating agent, and optionally at least one surfactant.

Another embodiment of the invention relates to a composition as defined hereinabove, wherein the peracetic acid is obtained by dissolving in water a powdered composition of 30-60% w/w of a solid hydrogen peroxide precursor, 5-40% w/w of a pH adjusting agent, and 10-40% w/w of an acetylating agent.

Optionally, said powdered composition may further contain at least one systemic enhancer, preferably when an agricultural use is considered, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is an C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a composition as defined hereinabove, wherein the hydrogen peroxide precursor is a sodium percarbonate, the pH adjusting agent is citric acid or ethylenediaminetetraacetic (EDTA) acid, and the acetylating agent is tetraacetylethylenediamine (TAED).

Another embodiment of the invention relates to a composition as defined hereinabove, wherein said compound defining the precursor of the metal cation is titanium dioxide or is a compound precursor of silver ions or oxysilver ions.

Another embodiment of the invention relates to a composition as defined hereinabove, wherein said compound defining the precursor of the metal cation is further defining a pest control agent such as a fungicide and/or bactericide.

Another embodiment of the invention relates to a composition as defined hereinabove, wherein said compound defining the precursor of the metal cation is a copper containing compound.

Another embodiment of the invention relates to a composition as defined hereinabove, wherein the said compound defining the precursor of the metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a composition as defined hereinabove, wherein said acid defines an acid complexing agent forming a complex with said metal cation.

Another embodiment of the invention relates to a composition as defined hereinabove, wherein wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a composition as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a composition as defined hereinabove, for the control of microbial pathogens present on surfaces, including but not limited to viruses, bacteria and fungi.

Another embodiment of the invention relates to a composition as defined hereinabove, wherein microbial pathogens are gram positive and gram negative bacteria.

Another embodiment of the invention relates to a composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a composition as defined hereinabove, wherein microbial pathogens are selected from the group consisting of Sharka (Plum pox potyvirus) D, M, C, Ea serogroups; Lettuce infectious yellows crinivirus; Tomato infectious yellows crinivirus; Tomato chlorosis crinivirus; Lettuce chlorosis crinivirus; Cucurbit yellow stunting disorder crinivirus; Sweet potato chlorotic stunt crinivirus; High Plains virus (sometimes complexed with wheat streak mosaic virus); Citrus tristeza closterovirus; Citrus tatterleaf capillovirus; Citrus chlorotic dwarf (unknown virus); Tomato spotted wilt tospovirus; Impatiens necrotic spot tospovirus; Tomato yellow leaf curl geminivirus; Raspberry bushy dwarf idaeovirus; and Blueberry shock ilarvirus.

Another embodiment of the invention relates to a composition as defined hereinabove, wherein microbial pathogens are selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a composition as defined hereinabove, wherein microbial pathogens are Escherichia coli, Staphylococcus aureus, Salmonella species, Listeria species, Mycobacterium tuberculosis, and viruses responsible for humans diseases such as influenza, foot and mouth disease, swine fever, etc.

Another embodiment of the invention relates to a composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a composition as defined hereinabove, wherein the growing plant is hemp.

Another embodiment of the invention relates to a composition as defined hereinabove, wherein the growing plant is a seed of the same.

Another embodiment of the invention relates to a composition as defined hereinabove, wherein it further comprises a SAR inducer, preferably at least one biopesticide which comprises a water soluble silicate salt defining the SAR inducer.

Another embodiment of the invention relates to a composition as defined hereinabove, wherein the water soluble silicate salt defining the SAR inducer is potassium silicate and further defines a fertilizer.

Another embodiment of the invention relates to a powdered composition which is a dry, water soluble mixture comprising:
(i) a peracetic acid precursor comprising:
   a) a solid hydrogen peroxide precursor,
   b) optionally a pH adjusting agent, and
   c) an acetylating agent;
(ii) optionally at least one surfactant;
(iii) a compound defining a precursor of a metal cation, preferably a metal cation comprising an element selected from the group consisting of Ag, Cu, Mn, Ti and Zn;
(iv) an acid selected from the group consisting of inorganic acids and organic acids; and
(v) optionally at least one excipient, additive and/or adjuvant;
   wherein upon addition of water said composition generates in situ peracetic acid (PAA) and wherein the ingredients (iii) and (iv) stabilize the peracetic acid for 1 to 48 hours at room temperature.

Another embodiment of the invention relates to the powdered composition defined hereinabove, wherein the dry, water soluble mixture comprises:
(i) about 30-90% w/w of the peracetic acid precursor comprising:
   (i)-a) about 30-60% w/w of the solid hydrogen peroxide precursor,
   (i)-b) about 10-40% w/w the pH adjusting agent,
   (i)-c) about 10-40% w/w of the acetylating agent; and
(ii) optionally the at least one surfactant;
(iii) about 0.01-5% w/w of the compound defining the precursor of the metal cation comprising the element selected from the group consisting of Ag, Cu, Mn, Ti and Zn, and
(iv) about 0.01-5% w/w of the acid selected from the group consisting of inorganic acids and organic acids;
(v) optionally the at least one excipient, additive and/or adjuvant;
   wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

Another embodiment of the invention relates to the powdered composition defined hereinabove, wherein optionally it may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is a C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to the powdered composition defined hereinabove, wherein the hydrogen peroxide precursor is sodium percarbonate, the pH adjusting agent is citric acid or ethylenediaminetetraacetic (EDTA) acid and the acetylating agent is tetraacetylethylenediamine (TAED).

Another embodiment of the invention relates to the powdered composition defined hereinabove, wherein said compound defining the precursor of the metal cation is titanium dioxide or a compound precursor of silver ions or oxysilver ions.

Another embodiment of the invention relates to the powdered composition defined hereinabove, wherein said compound defining the precursor of the metal cation is further defining a pest control agent such as a fungicide and/or bactericide.

Another embodiment of the invention relates to the powdered composition defined hereinabove, wherein said compound defining the precursor of the metal cation is a copper containing compound.

Another embodiment of the invention relates to the powdered composition defined hereinabove, wherein the said compound defining a precursor of a metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to the powdered composition defined hereinabove, wherein said acid defines an acid complexing agent forming a complex with said metal cation.

Another embodiment of the invention relates to the powdered composition defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to the powdered composition defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a powdered composition as defined hereinabove, for the control of microbial pathogens present on surfaces, including but not limited to viruses, bacteria and fungi.

Another embodiment of the invention relates to a powdered composition as defined hereinabove, wherein microbial pathogens are gram positive and gram negative bacteria.

Another embodiment of the invention relates to a powdered composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a powdered composition as defined hereinabove, wherein microbial pathogens are selected from the group consisting of Sharka (Plum pox potyvirus) D, M, C, Ea serogroups; Lettuce infectious yellows crinivirus; Tomato infectious yellows crinivirus; Tomato chlorosis crinivirus; Lettuce chlorosis crinivirus; Cucurbit yellow stunting disorder crinivirus; Sweet potato chlorotic stunt crinivirus; High Plains virus (sometimes complexed with wheat streak mosaic virus); Citrus tristeza closterovirus; Citrus tatterleaf capillovirus; Citrus chlorotic dwarf (unknown virus); Tomato spotted wilt tospovirus; Impatiens necrotic spot tospovirus; Tomato yellow leaf curl geminivirus; Raspberry bushy dwarf idaeovirus; and Blueberry shock ilarvirus.

Another embodiment of the invention relates to a powdered composition as defined hereinabove, wherein microbial pathogens are selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a powdered composition as defined hereinabove, wherein microbial pathogens are Escherichia coli, Staphylococcus aureus, Salmonella species, Listeria species, Mycobacterium tuberculosis, and viruses responsible for humans diseases such as influenza, foot and mouth disease, swine fever, etc.

Another embodiment of the invention relates to a powdered composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a powdered composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a powdered composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a powdered composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a powdered composition as defined hereinabove, wherein the growing plant is hemp.

Another embodiment of the invention relates to a powdered composition as defined hereinabove, wherein the growing plant is a seed of the same.

Another embodiment of the invention relates to a powdered composition as defined hereinabove, wherein it further comprises a SAR inducer, preferably up to 30% w/w of at least one biopesticide which comprises a the water soluble silicate salt defining the SAR inducer.

Another embodiment of the invention relates to a powdered composition as defined hereinabove, wherein the water soluble silicate salt defining the SAR inducer is potassium silicate and further defines a fertilizer.

Another embodiment of the invention relates to a pesticide composition comprising:
an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof,
a compound defining a precursor of a metal cation, preferably a metal cation comprising an element selected from the group consisting of Ag, Cu, Mn, Ti and Zn;
an acid selected from the group consisting of inorganic acids and organic acids, and
optionally at least one excipient, additive and/or adjuvant;
   to stabilize the oxidizer for 1 to 48 hours at room temperature, said metal cation or acid optionally further having bactericidal and/or fungicidal properties.

Another embodiment of the invention relates to a pesticide composition as defined hereinabove, wherein it comprises:
from 1 to 10000 ppm, preferably from 5 to 5000 ppm, of the oxidizer or the precursor thereof;
from 0.01 to 10 g/L, preferably from 0.1 g to 3 g/L of the compound defining the precursor of the metal cation, comprising the element selected from the group consisting of Ag, Cu, Mn, Ti and Zn;
from 0.1 to 10 g/L of the acid selected from the group consisting of inorganic acids and organic acids;
   and wherein the at least one excipient includes water, said pesticide composition then defining an aqueous solution.

Another embodiment of the invention relates to a pesticide composition as defined hereinabove, wherein the oxidizer is peracetic acid or a precursor thereof.

Another embodiment of the invention relates to a pesticide composition as defined hereinabove, wherein the peracetic acid is liquid peracetic acid.

Another embodiment of the invention relates to a pesticide composition as defined hereinabove, wherein the peracetic acid is obtained by dissolving in water a powdered composition of 30-60% w/w of a solid hydrogen peroxide precursor, 5-40% w/w a pH adjusting agent, 10-40% w/w of an acetylating agent, and optionally at least one surfactant.

Optionally, said powdered composition may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is an C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a pesticide composition as defined hereinabove, wherein the hydrogen peroxide precursor is a sodium percarbonate, the pH adjusting agent is citric acid or ethylenediaminetetraacetic (EDTA) acid, and the acetylating agent is tetraacetylethylenediamine (TAED).

Another embodiment of the invention relates to a pesticide composition as defined hereinabove, wherein said compound defining the precursor of the metal cation is titanium dioxide or a compound which is precursor of silver ions or oxysilver ions.

Another embodiment of the invention relates to a pesticide composition as defined hereinabove, wherein said compound defining the precursor of the metal cation is further defining a pest control agent such as a bactericide and/or a fungicide.

Another embodiment of the invention relates to a pesticide composition as defined hereinabove, wherein said compound defining the precursor of the metal cation is a copper containing compound.

Another embodiment of the invention relates to a pesticide composition as defined hereinabove, wherein the said compound defining a precursor of a metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a pesticide composition as defined hereinabove, wherein said acid defines an acid complexing agent forming a complex with said metal cation.

Another embodiment of the invention relates to a pesticide composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a pesticide composition as defined hereinabove, wherein the acid is selected from the group consisting of preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a pesticide composition as defined hereinabove, for the control of microbial pathogens present on surfaces, including but not limited to viruses, bacteria and fungi.

Another embodiment of the invention relates to a pesticide composition as defined hereinabove, wherein microbial pathogens are gram positive and gram negative bacteria.

Another embodiment of the invention relates to a pesticide composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a pesticide composition as defined hereinabove, wherein microbial pathogens are selected from the group consisting of Sharka (Plum pox potyvirus) D, M, C, Ea serogroups; Lettuce infectious yellows crinivirus; Tomato infectious yellows crinivirus; Tomato chlorosis crinivirus; Lettuce chlorosis crinivirus; Cucurbit yellow stunting disorder crinivirus; Sweet potato chlorotic stunt crinivirus; High Plains virus (sometimes complexed with wheat streak mosaic virus); Citrus tristeza closterovirus; Citrus tatterleaf capillovirus; Citrus chlorotic dwarf (unknown virus); Tomato spotted wilt tospovirus; Impatiens necrotic spot tospovirus; Tomato yellow leaf curl geminivirus; Raspberry bushy dwarf idaeovirus; and Blueberry shock ilarvirus.

Another embodiment of the invention relates to a pesticide composition as defined hereinabove, wherein microbial pathogens are selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a pesticide composition as defined hereinabove, wherein microbial pathogens are Escherichia coli, Staphylococcus aureus, Salmonella species, Listeria species, Mycobacterium tuberculosis, and viruses responsible for humans diseases such as influenza, foot and mouth disease, swine fever, etc.

Another embodiment of the invention relates to a pesticide composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a pesticide composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a pesticide composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a pesticide composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a pesticide composition as defined hereinabove, wherein the growing plant is hemp.

Another embodiment of the invention relates to a pesticide composition as defined hereinabove, wherein the growing plant is a seed of the same.

Another embodiment of the invention relates to a pesticide composition as defined hereinabove, wherein it further comprises a SAR inducer, preferably at least one biopesticide which comprises a water soluble silicate salt defining the SAR inducer.

Another embodiment of the invention relates to a pesticide composition as defined hereinabove, wherein the water soluble silicate salt defining the SAR inducer is potassium silicate and further defines a fertilizer.

Another embodiment of the invention relates to a powdered pesticide composition which is a dry, water soluble mixture comprising:
(i) a peracetic acid precursor comprising:
   a) a solid hydrogen peroxide precursor,
   b) optionally a pH adjusting agent, and
   c) an acetylating agent;
(ii) optionally at least one surfactant;
(iii) a compound defining a precursor of a metal cation, preferably a metal cation comprising an element selected from the group consisting of Ag, Cu, Mn, Ti and Zn;
(iv) an acid selected from the group consisting of inorganic acids and organic acids; and
(v) optionally at least one excipient, additive and/or adjuvant;
   wherein upon addition of water said composition generates in situ peracetic acid (PAA) and wherein the ingredients (iii) and (iv) stabilize the peracetic acid for 1 to 48 hours at room temperature.

Another embodiment of the invention relates to a powdered pesticide composition as defined hereinabove, wherein the dry, water soluble mixture comprises:
(i) about 30-90% w/w of the peracetic acid precursor comprising:
   (i)-a) about 30-60% w/w of the solid hydrogen peroxide precursor,
   (i)-b) about 10-40% w/w the pH adjusting agent,
   (i)-c) about 10-40% w/w of the acetylating agent; and
(ii) optionally the at least one surfactant;
(iii) about 0.01-5% w/w of the compound defining a precursor of a metal cation comprising an element selected from the group consisting of Ag, Cu, Mn, Ti and Zn;
(iv) about 0.01-5% w/w of the acid selected from the group consisting of inorganic acids and organic acids; and
(v) optionally the at least one excipient, additive and/or adjuvant;
   wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

Another embodiment of the invention relates to a powdered pesticide composition as defined hereinabove, wherein when intended for an agricultural use optionally may further contain at least one systemic enhancer preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is a C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a powdered pesticide composition as defined hereinabove, wherein the hydrogen peroxide precursor is a sodium percarbonate, the pH adjusting agent is citric acid or ethylenediaminetetraacetic (EDTA) acid and the acetylating agent is tetraacetylethylenediamine (TAED).

Another embodiment of the invention relates to a powdered pesticide composition as defined hereinabove, wherein said compound defining the precursor of the metal cation is titanium dioxide or a compound which is a precursor of silver ions or oxysilver ions.

Another embodiment of the invention relates to a powdered pesticide composition as defined hereinabove, wherein said compound defining the precursor of the metal cation is further defining a pest control agent such as a fungicide and/or bactericide.

Another embodiment of the invention relates to a powdered pesticide composition as defined hereinabove, wherein said compound defining the precursor of the metal cation is a copper containing compound.

Another embodiment of the invention relates to a powdered pesticide composition as defined hereinabove, wherein the said compound defining the precursor of the metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a powdered pesticide composition as defined hereinabove, wherein said acid defines an acid complexing agent forming a complex with said metal cation.

Another embodiment of the invention relates to a powdered pesticide composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a powdered pesticide composition as defined hereinabove, wherein the acid is selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a powdered pesticide composition as defined hereinabove, for the control of microbial pathogens present on surfaces, including but not limited to viruses, bacteria and fungi.

Another embodiment of the invention relates to a powdered pesticide composition as defined hereinabove, wherein microbial pathogens are gram positive and gram negative bacteria.

Another embodiment of the invention relates to a powdered pesticide composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a powdered pesticide composition as defined hereinabove, wherein microbial pathogens are selected from the group consisting of Sharka (Plum pox potyvirus) D, M, C, Ea serogroups; Lettuce infectious yellows crinivirus; Tomato infectious yellows crinivirus; Tomato chlorosis crinivirus; Lettuce chlorosis crinivirus; Cucurbit yellow stunting disorder crinivirus; Sweet potato chlorotic stunt crinivirus; High Plains virus (sometimes complexed with wheat streak mosaic virus); Citrus tristeza closterovirus; Citrus tatterleaf capillovirus; Citrus chlorotic dwarf (unknown virus); Tomato spotted wilt tospovirus; Impatiens necrotic spot tospovirus; Tomato yellow leaf curl geminivirus; Raspberry bushy dwarf idaeovirus; and Blueberry shock ilarvirus.

Another embodiment of the invention relates to a powdered pesticide composition as defined hereinabove, wherein microbial pathogens are selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a powdered pesticide composition as defined hereinabove, wherein microbial pathogens are Escherichia coli, Staphylococcus aureus, Salmonella species, Listeria species, Mycobacterium tuberculosis, and viruses responsible for humans diseases such as influenza, foot and mouth disease, swine fever, etc.

Another embodiment of the invention relates to a powdered pesticide composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a powdered pesticide composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a powdered pesticide composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a powdered pesticide composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a powdered pesticide composition as defined hereinabove, wherein the growing plant is hemp.

Another embodiment of the invention relates to a powdered pesticide composition as defined hereinabove, wherein the growing plant is a seed of the same.

Another embodiment of the invention relates to a powdered pesticide composition as defined hereinabove, wherein it further comprises a SAR inducer, preferably up to 30% w/w of at least one biopesticide which comprises a the water soluble silicate salt defining the SAR inducer.

Another embodiment of the invention relates to a powdered pesticide composition as defined hereinabove, wherein the water soluble silicate salt defining the SAR inducer is potassium silicate and further defines a fertilizer.

Another embodiment of the invention relates to a bactericidal composition comprising:
an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof,
a compound defining a precursor of a metal cation, preferably a metal cation comprising an element selected from the group consisting of Ag, Cu, Mn, Ti and Zn,
an acid selected from the group consisting of inorganic acids and organic acids, and
optionally at least one excipient, additive and/or adjuvant;
   to stabilize the oxidizer for 1 to 48 hours at room temperature.

Another embodiment of the invention relates to a bactericidal composition as defined hereinabove, wherein wherein it comprises:
from 1 to 10000 ppm, preferably from 5 to 5000 ppm, of the oxidizer or the precursor thereof;
from 0.01 to 10 g/L, preferably 0.1 g to 3 g/L of the compound defining the precursor of the metal cation comprising the element selected from the group consisting of Ag, Cu, Mn, Ti and Zn; and
from 0.1 to 10 g/L of the acid selected from the group consisting of inorganic acids and organic acids;
   and wherein the at least one excipient includes water, said bactericidal composition then defining an aqueous solution.

Another embodiment of the invention relates to a bactericidal composition as defined hereinabove, wherein the oxidizer is peracetic acid or a precursor thereof.

Another embodiment of the invention relates to a bactericidal composition as defined hereinabove, wherein the peracetic acid is liquid peracetic acid.

Another embodiment of the invention relates to a bactericidal composition as defined hereinabove, wherein the peracetic acid is obtained by dissolving in water a powdered composition of 30-60% w/w of a solid hydrogen peroxide precursor, 5-40% w/w a pH adjusting agent, 10-40% w/w of an acetylating agent, and optionally at least one surfactant.

Optionally, said powdered composition may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is an C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a bactericidal composition as defined hereinabove, wherein the hydrogen peroxide precursor is a sodium percarbonate, the pH adjusting agent is citric acid or ethylenediaminetetraacetic (EDTA) acid, and the acetylating agent is tetraacetylethylenediamine (TAED).

Another embodiment of the invention relates to a bactericidal composition as defined hereinabove, wherein said compound defining the precursor of the metal cation is titanium dioxide or a compound which is precursor of silver ions or oxysilver ions.

Another embodiment of the invention relates to a bactericidal composition as defined hereinabove, wherein said compound defining the precursor of the metal cation is further defining a pest control agent such as a bactericide and/or a fungicide.

Another embodiment of the invention relates to a bactericidal composition as defined hereinabove, wherein said compound defining the precursor of the metal cation is a copper containing compound.

Another embodiment of the invention relates to a bactericidal composition as defined hereinabove, wherein the said compound defining the precursor of the metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a bactericidal composition as defined hereinabove, wherein said acid defines an acid complexing agent forming a complex with said cation.

Another embodiment of the invention relates to a bactericidal composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a bactericidal composition as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a bactericidal composition as defined hereinabove, wherein the acid is phosphorous acid which is also provided with bactericidal properties.

Another embodiment of the invention relates to a bactericidal composition as defined hereinabove, useful as a bactericide for controlling gram negative and gram positive bacteria.

Another embodiment of the invention relates to a bactericidal composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a bactericidal composition as defined hereinabove, wherein microbial pathogens are Escherichia coli, Staphylococcus aureus, Salmonella species, Listeria species, Mycobacterium tuberculosis.

Another embodiment of the invention relates to a bactericidal composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a bactericidal composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a bactericidal composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a bactericidal composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a bactericidal composition as defined hereinabove, wherein the growing plant is hemp.

Another embodiment of the invention relates to a bactericidal composition as defined hereinabove, wherein the growing plant is a seed of the same.

Another embodiment of the invention relates to a bactericidal composition as defined hereinabove, wherein it further comprises a SAR inducer, preferably at least one biopesticide which comprises a water soluble silicate salt defining the SAR inducer.

Another embodiment of the invention relates to a bactericidal composition as defined hereinabove, wherein the water soluble silicate salt defining the SAR inducer is potassium silicate and further defines a fertilizer.

An embodiment of the invention relates to a powdered bactericidal composition which is a dry, water soluble mixture comprising:
(i) a peracetic acid precursor comprising:
   a) a solid hydrogen peroxide precursor,
   b) optionally a pH adjusting agent, and
   c) an acetylating agent;
(ii) optionally at least one surfactant;
(iii) a compound defining a precursor of a metal cation, preferably a metal cation comprising an element selected from the group consisting of Ag, Cu, Mn, Ti and Zn;
(iv) an acid selected from the group consisting of inorganic acids and organic acids; and
(v) optionally at least one excipient, additive and/or adjuvant;
   wherein upon addition of water said composition generates in situ peracetic acid (PAA) and wherein the ingredients (iii) and (iv) stabilize the peracetic acid for 1 to 48 hours at room temperature.

Another embodiment of the invention relates to a powdered bactericidal composition as defined hereinabove, wherein dry, water soluble mixture comprises:
(i) about 30-90% w/w of the peracetic acid precursor comprising:
   (i)-a) about 30-60% w/w of the solid hydrogen peroxide precursor,
   (i)-b) about 10-40% w/w the pH adjusting agent,
   (i)-c) about 10-40% w/w of the acetylating agent; and
(ii) optionally the at least one surfactant;
(iii) about 0.01-5% w/w of the compound defining the precursor of the metal cation comprising the element selected from the group consisting of Ag, Cu, Mn, Ti and Zn;
(iv) about 0.01-5% w/w of the acid selected from the group consisting of inorganic acids and organic acids; and (v) optionally the at least one excipient, additive and/or adjuvant;
   wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

Another embodiment of the invention relates to the powdered composition defined hereinabove, wherein optionally it may further contain at least one systemic enhancer, when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is a C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a powdered bactericidal composition as defined hereinabove, wherein the hydrogen peroxide precursor is a sodium percarbonate, the pH adjusting agent is citric acid or ethylenediaminetetraacetic (EDTA) acid and the acetylating agent is tetraacetylethylenediamine (TAED).

Another embodiment of the invention relates to a powdered bactericidal composition as defined hereinabove, wherein said compound defining the precursor of the metal cation is titanium dioxide or a compound which is precursor of silver ions or oxysilver ions.

Another embodiment of the invention relates to a powdered bactericidal composition as defined hereinabove, wherein said compound defining the precursor of the metal cation is further defining a pest control agent such as a fungicide and/or bactericide.

Another embodiment of the invention relates to a powdered bactericidal composition as defined hereinabove, wherein said compound defining the precursor of the metal cation is a copper containing compound.

Another embodiment of the invention relates to a powdered bactericidal composition as defined hereinabove, wherein the said compound defining the precursor of the metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a powdered bactericidal composition as defined hereinabove, wherein said acid defines an acid complexing agent forming a complex with said metal cation.

Another embodiment of the invention relates to a powdered bactericidal composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a powdered bactericidal composition as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a powdered bactericidal composition as defined hereinabove, wherein the acid is phosphorous acid which is also provided with bactericidal properties.

Another embodiment of the invention relates to a powdered bactericidal composition as defined hereinabove, useful as a bactericide for controlling gram negative and gram positive bacteria.

Another embodiment of the invention relates to a powdered bactericidal composition as defined hereinabove, wherein bacteria are selected from the group consisting of Agrobacterium, Clavibacter, Erwinia, Pseudomonas, Xanthomonas, Streptomyces, Burholdaria and Xylella.

Another embodiment of the invention relates to a powdered bactericidal composition as defined hereinabove, wherein microbial pathogens are Escherichia coli, Staphylococcus aureus, Salmonella species, Listeria species, Mycobacterium tuberculosis.

Another embodiment of the invention relates to a powdered bactericidal composition as defined hereinabove, and for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a powdered bactericidal composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a powdered bactericidal composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a powdered bactericidal composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a powdered bactericidal composition as defined hereinabove, wherein the growing plant is hemp.

Another embodiment of the invention relates to a powdered bactericidal composition as defined hereinabove, wherein the growing plant is a seed of the same.

Another embodiment of the invention relates to a powdered bactericidal composition as defined hereinabove, wherein it further comprises a SAR inducer, preferably at least one biopesticide which comprises a water soluble silicate salt defining the SAR inducer.

Another embodiment of the invention relates to a powdered bactericidal composition as defined hereinabove, wherein the water soluble silicate salt defining the SAR inducer is potassium silicate and further defines a fertilizer.

Another embodiment of the invention relates to a fungicidal composition comprising:
an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof,
a compound defining a precursor of a metal cation, preferably a metal cation comprising an element selected from the group consisting of Ag, Cu, Mn, Ti and Zn;
an acid selected from the group consisting of inorganic acids and organic acids; and
optionally at least one excipient, additive and/or adjuvant;
   to stabilize the oxidizer for 1 to 48 hours at room temperature.

Another embodiment of the invention relates to a fungicidal composition as defined hereinabove, wherein it comprises:
from 1 to 10000 ppm, preferably from 5 to 5000 ppm, of the oxidizer or the precursor thereof;
from 0.01 to 10 g/L, preferably from 0.1 g to 3 g/L of a compound defining the precursor of the metal cation comprising the element selected from the group consisting of Ag, Cu, Mn, Ti and Zn;
from 0.1 to 10 g/L of the acid selected from the group consisting of inorganic acids and organic acids;
   and wherein the at least one excipient includes water, said fungicidal composition then defining an aqueous solution.

Another embodiment of the invention relates to a fungicidal composition as defined hereinabove, wherein the peracetic acid is obtained by dissolving in water a powdered composition of 30-60% w/w of a solid hydrogen peroxide precursor, 5-40% w/w a pH adjusting agent, 10-40% w/w of an acetylating agent, and optionally at least one surfactant.

Optionally, said powdered composition may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is an C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a fungicidal composition as defined hereinabove, wherein the hydrogen peroxide precursor is a sodium percarbonate, the pH adjusting agent is citric acid or ethylenediaminetetraacetic (EDTA) acid, and the acetylating agent is tetraacetylethylenediamine (TAED).

Another embodiment of the invention relates to a fungicidal composition as defined hereinabove, wherein said compound defining the precursor of the metal cation is titanium dioxide or a compound which is precursor of silver ions or oxysilver ions.

Another embodiment of the invention relates to a fungicidal composition as defined hereinabove, wherein said compound defining the precursor of the metal cation is further defining a pest control agent such as a fungicide and/or bactericide.

Another embodiment of the invention relates to a fungicidal composition as defined hereinabove, wherein said compound defining the precursor of the metal cation is a copper containing compound.

Another embodiment of the invention relates to a fungicidal composition as defined hereinabove, wherein the said compound defining the precursor of the metal cation is copper hydroxide, copper oxide, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a fungicidal composition as defined hereinabove, wherein said acid defines an acid complexing agent forming a complex with said metal cation.

Another embodiment of the invention relates to a fungicidal composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a fungicidal composition as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a fungicidal composition as defined hereinabove, for the control of fungi selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a fungicidal composition as defined hereinabove, for use in agriculture, wherein the surfaces are surfaces of a growing plant or a seed of said plant; and wherein the precursor of a metal cation, the acid and the optionally at least one excipient, additive and/or adjuvant, are all agriculturally acceptable;

Another embodiment of the invention relates to a fungicidal composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a fungicidal composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a fungicidal composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a fungicidal composition as defined hereinabove, wherein the growing plant is hemp.

Another embodiment of the invention relates to a fungicidal composition as defined hereinabove, wherein the growing plant is a seed of the same.

Another embodiment of the invention relates to a fungicidal composition as defined hereinabove, wherein it further comprises a SAR inducer, preferably at least one biopesticide which comprises a water soluble silicate salt defining the SAR inducer.

Another embodiment of the invention relates to a fungicidal composition as defined hereinabove, wherein the water soluble silicate salt defining the SAR inducer is potassium silicate and further defines a fertilizer.

Another embodiment of the invention relates to a powdered fungicide composition which is a dry, water soluble mixture comprising:
(i) a peracetic acid precursor comprising:
   (i)-a) a solid hydrogen peroxide precursor,
   (i)-b) optionally a pH adjusting agent, and
   (i)-c) an acetylating agent;
(ii) optionally at least one surfactant;
(iii) a compound defining a precursor of a metal cation, preferably a metal cation comprising an element selected from the group consisting of Ag, Cu, Mn, Ti and Zn;
(iv) an acid selected from the group consisting of inorganic acids and organic acids; and
(v) optionally at least one excipient, additive and/or adjuvant;
   wherein upon addition of water said composition generates in situ peracetic acid (PAA) and wherein the ingredients (iii) and (iv) stabilize the peracetic acid for 1 to 48 hours at room temperature.

Another embodiment of the invention relates to a powdered fungicide composition as defined hereinabove, wherein the dry, water soluble mixture comprises:
(i) about 30-90% w/w of the peracetic acid precursor comprising:
   (i)-a) about 30-60% w/w of the solid hydrogen peroxide precursor,
   (i)-b) about 10-40% w/w the pH adjusting agent,
   (i)-c) about 10-40% w/w of the acetylating agent; and
(ii) optionally the at least one surfactant;
(iii) about 0.01-5% w/w the compound defining the precursor of the metal cation comprising the element selected from the group consisting of Ag, Cu, Mn, Ti and Zn; and
(iv) about 0.01-5% w/w of the acid selected from the group consisting of inorganic acids and organic acids and
(v) optionally the at least one excipient, additive and/or adjuvant;
   wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

Another embodiment of the invention relates to the powdered composition defined hereinabove, wherein optionally it may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is a C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to the powdered composition defined hereinabove, wherein the hydrogen peroxide precursor is a sodium percarbonate, the pH adjusting agent is citric acid or ethylenediaminetetraacetic (EDTA) acid and the acetylating agent is tetraacetylethylenediamine (TAED).

Another embodiment of the invention relates to a powdered fungicide composition as defined hereinabove, wherein said compound defining the precursor of the metal cation is titanium dioxide or a compound which is precursor of silver ions or oxysilver ions.

Another embodiment of the invention relates to a powdered fungicide composition as defined hereinabove, wherein said compound defining the precursor of the metal cation is further defining a pest control agent such as a fungicide and/or bactericide.

Another embodiment of the invention relates to a powdered fungicide composition as defined hereinabove, wherein said compound defining the precursor of the metal cation is a copper containing compound.

Another embodiment of the invention relates to a powdered fungicide composition as defined hereinabove, wherein the said compound defining the precursor of the metal cation is copper hydroxide, copper oxide, copper oxychloride, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a powdered fungicide composition as defined hereinabove, wherein said acid defines an acid complexing agent forming a complex with said metal cation.

Another embodiment of the invention relates to a powdered fungicide composition as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a powdered fungicide composition as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a powdered fungicidal composition as defined hereinabove, for the control of fungi selected from the group consisting of Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; and the genus Phytophthora (including the causal agents of potato late blight and sudden oak death; Pythium spp.; and Phytophthora spp).

Another embodiment of the invention relates to a powdered fungicidal composition as defined hereinabove, for use in agriculture, wherein the surfaces are surfaces of a growing plant or a seed of said plant; and wherein the precursor of a metal cation, the acid and the optionally at least one excipient, additive and/or adjuvant, are all agriculturally acceptable.

Another embodiment of the invention relates to a powdered fungicidal composition as defined hereinabove, wherein the growing plant is a fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

Another embodiment of the invention relates to a powdered fungicidal composition as defined hereinabove, wherein the growing plant is selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another embodiment of the invention relates to a powdered fungicidal composition as defined hereinabove, wherein the growing plant is selected from the group consisting of roots such as potatoes, or cereals such as corn, rice, wheat, barley, sorghum, millet, oats, ryes, triticale, fonio, teff, buckwheat, quinoa, etc.

Another embodiment of the invention relates to a powdered fungicidal composition as defined hereinabove, wherein the growing plant is hemp.

Another embodiment of the invention relates to a powdered fungicidal composition as defined hereinabove, wherein the growing plant is a seed of the same.

Another embodiment of the invention relates to a powdered fungicidal composition as defined hereinabove, wherein it further comprises a SAR inducer, preferably at least one biopesticide which comprises a water soluble silicate salt defining the SAR inducer.

Another embodiment of the invention relates to a powdered fungicidal composition as defined hereinabove, wherein the water soluble silicate salt defining the SAR inducer is potassium silicate and further defines a fertilizer.

Another embodiment of the invention relates to a method for improving the stability and/or efficiency of a composition of an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof, from 1 to 48 hours at room temperature, said method comprising a step of admixing with the oxidizer or a precursor thereof,
a compound defining a precursor of a metal cation, preferably a metal cation comprising an element selected from the group consisting of Ag, Cu, Mn, Ti and Zn;
an acid selected from the group consisting of inorganic acids and organic acids, and
optionally at least one excipient, additive and/or adjuvant.

Another embodiment of the invention relates to a method for improving the stability and/or efficiency for 1 to 48 hours at room temperature, of an oxidizer, preferably peracetic acid, hydrogen peroxide, or a compound which is selected from the group consisting of compounds which are precursors of chlorine ions, bromine ions, or iodine ions, more preferably peracetic acid, or a precursor thereof, present in at least one excipient including water and in an amount of from 1 to 10000 ppm, preferably from 10-5000 ppm; said method comprising a step of admixing with said excipient including water:
from 0.01 to 10 g/L, preferably from 0.1 g to 3 g/L of a compound defining a precursor of a metal cation, preferably a metal cation comprising an element selected from the group consisting of Ag, Cu, Mn, Ti and Zn;
from 0.1 to 10 g/L of an acid selected from the group consisting of inorganic acids and organic acids, and
optionally at least one additive and/or adjuvant.

Another embodiment of the invention relates to a method as defined hereinabove, wherein the oxidizer is peracetic acid or a precursor thereof.

Another embodiment of the invention relates to a method as defined hereinabove, wherein the oxidizer is liquid peracetic acid.

Another embodiment of the invention relates to a method as defined hereinabove, wherein the peracetic acid is obtained by dissolving in water a powdered composition of 30-60% w/w of a solid hydrogen peroxide precursor, 5-40% w/w a pH adjusting agent, 10-40% w/w of an acetylating agent, and optionally at least one surfactant.

Optionally, said powdered composition may further contain at least one systemic enhancer, preferably when intended for an agricultural use, and/or at least one surfactant. As a non-limiting example, the systemic enhancer may be potassium silicate. As a non-limiting example, the surfactant may be an anionic surfactant, a non-ionic surfactant, a cationic surfactant, or an amphoteric surfactant. Any kind of surfactant may be considered. Preferably and nonlimitatively, said powdered composition may comprise up to 4% w/w of a surfactant which is an C₁₂₋₁₆ alpha olefin surfactant, more preferably a surfactant such as the one sold under the trademark BIO-TERGE® AS-90 (sodium C₁₄₋₁₆ olefin sulfonate).

Another embodiment of the invention relates to a method as defined hereinabove, wherein the hydrogen peroxide precursor is a sodium percarbonate, the pH adjusting agent is citric acid or ethylenediaminetetraacetic (EDTA) acid, and the acetylating agent is tetraacetylethylenediamine (TAED).

Another embodiment of the invention relates to a method as defined hereinabove, wherein said compound defining the precursor of the metal cation is titanium dioxide or a compound which is precursor of silver ions or oxysilver ions.

Another embodiment of the invention relates to a method as defined hereinabove, wherein said compound defining the precursor of the metal cation is further defining a fungicide, preferably a fungicide.

Another embodiment of the invention relates to a method as defined hereinabove, wherein said compound defining the precursor of the metal cation is a copper containing compound.

Another embodiment of the invention relates to a method as defined hereinabove, wherein the said compound defining the precursor of the metal cation is copper hydroxide, copper oxide, copper sulphate, copper phosphonate, copper octanoate (such as CUEVA®), copper soap, copper ammonium complex, a mixture of copper oxychloride and copper hydroxide (such as BADGE®) or any copper-based fungicide and/or bactericide.

Another embodiment of the invention relates to a method as defined hereinabove, wherein said acid defines an acid complexing agent forming a complex with said metal cation.

Another embodiment of the invention relates to a method as defined hereinabove, wherein the acid complexing agent is selected from the group consisting of ethylenediaminetetraacetic acid (EDTA), nitrilotriacetic acid (NTA), diethylenetriaminepentaacetic acid (DTPA), 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), sodium salt of 1,2-diaminoethanetetrakis(methylenephosphonic acid), potassium salt of 1,2-diaminoethanetetrakis(methylenephosphonic acid), ammonium salt of 1,2-diaminoethanetetrakis(methylenephosphonic acid), aminotrimethylenephosphonic acid (ATMP), ethylenediaminetetra(methylenephosphonic acid) (EDTMPA Solid), phosphonobutanetricarboxylic acid, (PBTCA), polyhydric alcohol phosphate ester (PAPE), 2-hydroxyphosphonocarboxylic acid (HPAA), hexamethylenediaminetetra(methylenephosphonic acid) HMDTMPA, and mixtures thereof.

Another embodiment of the invention relates to a method as defined hereinabove, wherein the acid is preferably selected from the group consisting of hydrochloric acid, nitric acid, oxalic acid, phosphoric acid, phosphorous acid, sulfamic acid, formic acid, lactic acid and sulfuric acid, and more preferably from the group consisting of phosphorous acid, phosphoric acid and sulfamic acid.

Another embodiment of the invention relates to a method as defined hereinabove, wherein the precursor of a metal cation, the acid and the optionally at least one excipient, additive and/or adjuvant, are all agriculturally acceptable.

Another embodiment of the invention relates to a use of a composition as defined hereinabove for the treatment of a surface, preferably of a tissue of a growing plant, in order to control the presence of pathogens thereupon.

Another embodiment of the invention relates to a use of a powdered composition as defined hereinabove for the preparation of an aqueous solution comprising peracetic acid, preferably at a concentration not harmful for a plant, for the treatment of a surface, preferably of a tissue of a growing plant, in order to control the presence of pathogens thereupon.

Another embodiment of the invention relates to a use a pesticide composition as defined hereinabove, as a pesticide for the treatment of a surface, preferably of a tissue of a growing plant, in order to control the presence of pests thereupon.

Another embodiment of the invention relates to a use of a powdered pesticide composition defined hereinabove, for the preparation of a pesticide aqueous solution comprising peracetic acid, preferably at a concentration not harmful for a plant, for the treatment of a surface, preferably of a tissue of a growing plant, in order to control the presence of pests thereupon.

Another embodiment of the invention relates to a use of a bactericidal composition as defined hereinabove, as a bactericide for the treatment of a surface, preferably of a tissue of a growing plant, in order to control the presence of bacteria thereupon.

Another embodiment of the invention relates to a use of a powdered bactericidal composition as defined hereinabove, wherein the treatment of the growing plant is controlling the presence of Xanthomonas on strawberry plant.

Another embodiment of the invention relates to a use of a powdered bactericidal composition as defined hereinabove, wherein the treatment of the growing plant is controlling the presence of Burholdaria on rice plant.

Another embodiment of the invention relates to a use of a powdered bactericidal composition as defined hereinabove, for the preparation of a bactericidal aqueous solution comprising peracetic acid, preferably at a concentration not harmful for a plant, for the treatment of a surface, preferably of a tissue of a growing plant, in order to control the presence of bacteria thereupon.

Another embodiment of the invention relates to a use of a powdered bactericidal composition as defined hereinabove, wherein the treatment of the growing plant is controlling the presence of Xanthomonas on strawberry plant.

Another embodiment of the invention relates to a use of a powdered bactericidal composition as defined hereinabove, wherein the treatment of the growing plant is controlling the presence of Burholdaria on rice plant.

Another embodiment of the invention relates to a use of a fungicidal composition as defined hereinabove, as a fungicide for the treatment of a surface, preferably of a tissue of a growing plant, in order to control the presence of fungi thereupon.

Another embodiment of the invention relates to a use of a powdered fungicidal composition defined hereinabove, for the preparation of a fungicidal aqueous solution comprising peracetic acid, preferably at a concentration not harmful for a plant, for the treatment of a surface, preferably of a tissue of a growing plant, in order to control the presence of fungi thereupon.

Another embodiment of the invention relates to a method for the treatment of a surface, preferably of a tissue a growing plant, in order to control pathogens thereupon, said method comprising at least one step of applying to said surface, preferably said tissue of the growing plant, a composition as defined hereinabove.

Another embodiment of the invention relates to a method for the treatment of a surface, preferably of a tissue of a growing plant, in order to control pathogens thereupon, said method comprising at least one step of applying to said surface, preferably said tissue of the growing plant, an aqueous composition prepared from a powdered composition as defined hereinabove.

Another embodiment of the invention relates to a method for the treatment of a surface, preferably of a tissue of a growing plant, in order to control pests thereupon, said method comprising at least one step of applying to said surface, preferably said tissue of the growing plant, a pesticide composition as defined hereinabove.

Another embodiment of the invention relates to a method for the treatment of a tissue of a surface, preferably of a growing plant, in order to control pests thereupon, said method comprising at least one step of applying to said surface, preferably said tissue of the growing plant, an aqueous pesticide composition prepared from a powdered pesticide composition as defined hereinabove.

Another embodiment of the invention relates to a method for the treatment of a surface, preferably of a tissue of a growing plant, in order to control bacteria thereupon, said method comprising at least one step of applying to said surface, preferably said tissue of the growing plant, a bactericide composition as defined hereinabove.

Another embodiment of the invention relates to a method as defined hereinabove, for the treatment of Xanthomonas on strawberry plant.

Another embodiment of the invention relates to a method as defined hereinabove, for the treatment of Burholdaria on rice plant.

Another embodiment of the invention relates to a method for the treatment of a surface, preferably of a tissue of a growing plant, in order to control bacteria thereupon, said method comprising at least one step of applying to said surface, preferably said tissue of the growing plant, an aqueous bactericide composition prepared from a powdered bactericide composition as defined hereinabove.

Another embodiment of the invention relates to a method as defined hereinabove for controlling the presence of Xanthomonas on strawberry plant.

Another embodiment of the invention relates to a method as defined hereinabove for controlling the presence of Burholdaria on rice plant.

Another embodiment of the invention relates to a method for the treatment of a surface, preferably of a tissue of a growing plant, in order to control fungi thereupon, said method comprising at least one step of applying to said surface, preferably said tissue of the growing plant, a fungicide composition as defined hereinabove.

Another embodiment of the invention relates to a method for the treatment of a surface, preferably of a tissue of a growing plant, in order to control fungi thereupon, said method comprising at least one step of applying to said surface, preferably said tissue of the growing plant, an aqueous fungicide composition prepared from a powdered fungicide composition as defined hereinabove.

Another embodiment of the invention relates to a kit for carrying out a method as defined hereinabove, wherein said kit comprises in distinct containers:
the oxidizer, preferably peracetic acid, hydrogen peroxide, or a compound which is selected from the group consisting of compounds which are precursors of chlorine ions, bromine ions, or iodine ions, more preferably peracetic acid, or precursor thereof;
the compound defining the precursor of the metal cation, preferably the metal cation comprising the element selected from the group consisting of Ag, Cu, Mn, Ti and Zn;
the acid selected from the group consisting of inorganic acids and organic,
optionally the at least one excipient including water, additive and/or adjuvant; and
a notice of instruction for dilution in the at least one excipient including water.

Another embodiment of the invention relates to a kit for carrying out a method as defined hereinabove, wherein said kit comprises in distinct containers:

a composition as defined hereinabove;

and a notice of instruction for dilution in an excipient.

Another embodiment of the invention relates to a kit for carrying out a method as defined hereinabove, wherein said kit comprises in distinct containers:

a powdered composition as defined hereinabove;

and a notice of instruction for dilution in water.

Another embodiment of the invention relates to a kit for carrying out a method as defined hereinabove, wherein said kit comprises in distinct containers:

a pesticide composition as defined hereinabove;

and a notice of instruction for dilution in an excipient.

Another embodiment of the invention relates to a kit for carrying out a method as defined hereinabove, wherein said kit comprises in distinct containers:

a powdered pesticide composition as defined hereinabove;

and a notice of instruction for dilution in water.

Another embodiment of the invention relates to a kit for carrying out a method as defined hereinabove, wherein said kit comprises in distinct containers:

a bactericide composition as defined hereinabove;

and a notice of instruction for dilution in an excipient.

Another embodiment of the invention relates to a kit for carrying out a method as defined hereinabove, wherein said kit comprises in distinct containers:

a powdered bactericide composition as defined hereinabove;

and a notice of instruction for dilution in water.

Another embodiment of the invention relates to a kit for carrying out a method as defined hereinabove, wherein said kit comprises in distinct containers:

a fungicide composition as defined hereinabove;

and a notice of instruction for dilution in an excipient.

Another embodiment of the invention relates to a kit for carrying out a method as defined hereinabove, wherein said kit comprises in distinct containers:

a powdered fungicide composition as defined hereinabove;

and a notice of instruction for dilution in water.

According to a particularly preferred embodiment, the term “acetylating agent” refers to any suitable product which is capable of reacting in solution with the solid hydrogen peroxide precursor for generating peracetic acid. Examples include acetylsalicylic acid and tetraacetylethylenediamine (TAED).

According to a particularly preferred embodiment, the acetylating agent is TAED. Upon addition of water (e.g. dissolution of the mixture) it will be possible to obtain an aqueous solution where the solid hydrogen peroxide and the TAED will react and generate peracetic acid (PAA).

The principles of reaction: this reaction is summarized by the following equation:

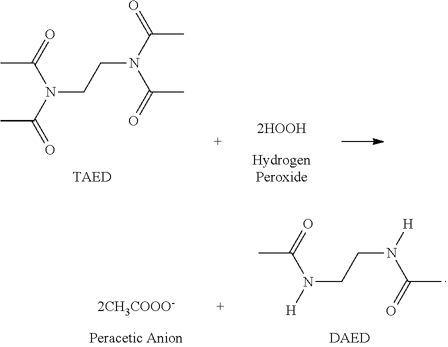

According to a particularly preferred embodiment, the term “solid hydrogen peroxide precursor” refers to any suitable dry product which is capable of generating hydrogen peroxide once dissolved in water. Suitable examples according to the invention include, but are not limited to, sodium percarbonate (coated or not), sodium peroxyhydrate, sodium perborate monohydrate, sodium perborate tetrahydrate, sodium persulfate, potassium perborate, ammonium percarbonate. In preferred embodiments, the solid hydrogen peroxide is coated sodium percarbonate. Once coated, the sodium percarbonate is provided with at least one coat of a substance allowing improvement of storage and rheology. The nature of the coating does not significantly affect the efficiency of aqueous composition to be obtained.

According to a particularly preferred embodiment, the term “pH adjusting agent” refers to any suitable dry product which is capable of adjusting pH of the aqueous solution. Examples of suitable pH adjusting agents according to the invention include, but are not limited to, citric acid, phosphoric acid, nitric acid, hydrochloric acid, glycolic acid, weak acids (e.g. formic acid, acetic acid, hydrofluoric acid, nitrous acid, hydrocyanic acid, benzoic acid), organic acids (e.g. carboxylic acid, lactic acid, acetic acid, citric acid, oxalic acid) and sulfamic acid. In preferred embodiments, the pH adjusting agent is citric acid. It is within the knowledge of those skilled in the art to identify and select a pH adjusting agent which can reduce the pH according to the invention.

According to a particularly preferred embodiment, the systemic enhancer may be selected amongst a broad list of systemic enhancers known to the skilled workman, and more preferably it may be a pesticide or a biopesticide which refer to any suitable product which can provide a source of silicate, more preferably a water soluble silicate salt, more preferably a potassium silicate. Preferably, such a biopesticides may also represent but are not limited to, potassium silicate, sodium silicate, sodium metasilicate. In preferred embodiments, the biopesticide is potassium silicate and it can provide both potassium and silicate.

Since preferred embodiments concerns agricultural uses (e.g. human consumption) those skilled in the art will understand that preferred compounds include those compounds which are non-toxic to human, and more preferably those certified as “food grade”. Furthermore, the solid hydrogen peroxide, the optional pH adjusting agent, the acetylating agent (e.g. tetraacetylethylenediamine (TAED)), the systemic enhancer, and are preferably selected in proportions maximizing generation of peracetic acid, while remaining non-toxic to plants and more preferably, they are at concentrations providing beneficial effects on controlling pathogenic organisms and eventually, concerning some possible systemic enhancers, further contributing as a collateral effect to the fertilization of the soils (e.g. addition of potassium ions to the soil). The compounds comprised in the composition according to the invention are commercially available and may be purchased from many suppliers such as Univar Canada Ltd, Brenntag, Kingsfield Inc., Debro Chemicals, Warwick International Ltd., and/or MULTICHEM®.

In preferred embodiments, the powdered composition of the invention may be marketed as concentrate and an end user dilutes the concentrate to a use aqueous solution. The level of active components in the powdered composition may be dependent upon the intended dilution factor and desired activity in the use solution. In one particular embodiment, the mixture is formulated such that 2 g of the powdered composition in 1000 g of water generates about 200 ppm of peracetic acid (PAA) at pH 8.0±3.0. This may occur within about 1 min to 24 hrs.

Those skilled in the art know how to monitor levels of peracetic in solutions. For instance, it is known to use iodometric titration (F. P. Greenspan and D. G. MacKellar, 1948, Anal. Chem., 20, 1061) or to use analytical test strips. Suitable test strips include those manufactured by Merck and which are currently available under two different formats (i.e. 5-50 ppm and 100-500 ppm). These test strips provide a rapid, convenient semi-quantitative method of determining peracetic levels. LaMotte Company (Chestertown, Md., USA) also provides a test kit (code 7191-01) for titrating peracetic acid.

In addition, the powdered compositions of the invention may also contain additional ingredients such as additives, said ingredients including but not limited to metal scavengers, coating agents, preserving agents, solubilizing agents, stabilizing agents, wetting agents, emulsifiers, colorants (e.g. tracer dyes), odorants, salts, buffers, surfactants, solvents, coating agents and/or antioxidants. For preparing the composition of the invention, methods well known in the art may be used.

The powdered compositions of the invention may be packaged under different forms, such as a pouch (e.g. bag), a tablet (e.g. puck), or a sealed container (e.g. bucket, plastic bottle, plastic pail, plastic drum, plastic tote), etc.

Agricultural uses: Those skilled in the art will readily appreciate that the mixture or compositions of the invention possesses numerous beneficial properties. For instance, aqueous solutions prepared using such mixture or composition may increase plant growth by providing oxygen to plant roots and act as a bactericide and fungicide by releasing hydrogen peroxide and peracetic acid. The systemic enhancer stimulates the plant natural defenses to diseases (e.g. powdery mildew, gray mold rot (Botrytis cinerea) on blueberry) and pests (e.g. mites, aphids, whiteflies). The combined use of peracetic acid and at least one systemic enhancer, more preferably a systemic enhancer defining a biopesticide comprising silicate ions, surprisingly shows a synergistic activity, especially but not limitatively, an amplification of plant defense responses to fungal infection, thereby enhancing the plant defenses against attack from powdery mildew, and other fungal diseases and insects, improving resistance to mineral stress, decreasing climate stress and further improving overall strength and increasing growth and yield.

Accordingly, additional aspects of the invention relates to methods for controlling microbial pathogens on a tissue of a growing plant. As used herein, the term “microbial pathogen” refers to any microorganism susceptible to harm a living plant, damage a living plant or negatively influence the viability or growth of a living plant. The term microbial pathogen encompasses viruses, bacteria, and fungi.

The invention encompasses controlling microbial pathogens including, but not limited to gram positive and gram negative bacteria. Bacteria against which the methods and compositions of the invention may be useful include, but are not limited to, Agrobacterium, Clavibacter, Erwinia, Pseudomonas, Xanthomonas, Streptomyces, Burholdaria and Xylella.

The invention encompasses controlling microbial pathogens including, but not limited to viruses. Viruses against which the methods and compositions of the invention may be useful include, but are not limited to, Sharka (Plum pox potyvirus) D, M, C, Ea serogroups; Lettuce infectious yellows crinivirus; Tomato infectious yellows crinivirus; Tomato chlorosis crinivirus; Lettuce chlorosis crinivirus; Cucurbit yellow stunting disorder crinivirus; Sweet potato chlorotic stunt crinivirus; High Plains virus (sometimes complexed with wheat streak mosaic virus); Citrus tristeza closterovirus; Citrus tatterleaf capillovirus; Citrus chlorotic dwarf (unknown virus); Tomato spotted wilt tospovirus; Impatiens necrotic spot tospovirus; Tomato yellow leaf curl geminivirus; Raspberry bushy dwarf idaeovirus; Blueberry shock ilarvirus.

The invention encompasses controlling microbial pathogens including, but not limited to viruses, bacteria and fungi. Examples of microbial pathogens against which the methods and compositions of the invention may be useful include, but are not limited to, Fusarium spp. (causal agents of Fusarium wilt disease); Thielaviopsis spp. (causal agents of: canker rot, black root rot, Thielaviopsis root rot); Verticillium spp.; Magnaporthe grisea (T. T. Hebert) M. E. Barr; causes blast of rice and gray leaf spot in turfgrasses; Rhizoctonia spp.; Phakospora pachyrhizi Sydow (causes Soybean rust); Puccinia spp.; the genus Phytophthora (includes the causal agents of potato late blight and sudden oak death; Pythium spp.; Phytophthora spp).

The invention encompasses controlling microbial pathogens which may be harmful to humans. Human pathogens against which the methods and compositions of the invention may be useful include, but are not limited to, Escherichia coli, Staphylococcus aureus, Salmonella species, Listeria species, Mycobacterium tuberculosis, and viruses responsible for humans diseases such as influenza, foot and mouth disease, swine fever, etc.

The methods and compositions of the invention may be beneficial to many different plants and tissues. Examples of plant tissue encompassed by the present invention include, but are not limited to, the leaves, stems, flowers, fruits, tubers, corms, roots, etc. In preferred embodiment, the plant tissue is a leaf.

Examples of plants encompassed by the present invention include, but are not limited to, fruit (such as apricot, apple, banana, berry, blackberry, blueberry, cherry, cranberry, currant, greengage, grape, grapefruit, gooseberry, lemon, mandarin, melon, orange, pear, peach, pineapple, plum, raspberry, strawberry, sweet cherry, watermelon, wild strawberry, etc.), vegetables (such as artichoke, bean, beetroot, broad bean, broccoli, cabbage, carrot, cauliflower, celery, chicory, chives, cress, corn, cucumber, curly kale, dill, eggplant, garlic, kohlrabi, lettuce, onion, paprika, parsnip, parsley, pea, pore, pumpkin, radish, shallot, small radish, spinach, swede turnip, tomato, turnip, etc.) and flowers (such as amaryllis, aster, anemone, azalea, begonia, bluebell, baby's breath, chrysanthemum, clover, crocus, freesia, gladiola, lily, daisy, bee balm, bergamot, bell flower, bird of paradise, bottlebrush, calla lily, columbine, orchid, daffodil, primrose, forget-me-not, foxglove, iris, lilac, marjoram, orange blossom, peach blossom, petunia, rosemary, sage, thyme, thistle, hyacinth, lady's slipper, amaranthus, marigold, mimosa, peony, rose, holly, lavender, snapdragon, carnation, sunflower, tansy, tulip, buttercup, zinnia, etc.), turf grasses and long grasses.

More particularly, the plant may be selected from the group consisting of baking apples, eating apples, sauce apples, apricot, banana, blackberry, blueberry, cantaloupe, cherry, cranberry, currant, raisin grapes, seed grapes, table grapes, wine grapes, greengage, gooseberry, honeydew, lemon, mandarin, melon, orange, peach, Anjou pears, Asian pears, Bartlett pears, Bosc pears, Comice pears, Red Bartlett pears, Seckel pears, pineapple, plum, raspberry, strawberry, sweet cherry, watermelon, wild strawberry, artichoke, bean, beetroot, broad bean, broccoli, cabbage, Argentine canola, Polish canola, seed canola, carrot, cauliflower, celery, chicory, chives, cress, burpless cucumbers, pickling cucumbers, slicing cucumbers, space-saver cucumbers, specialty cucumbers, curly kale, dill, eggplant, kohlrabi, butterhead lettuces, cos/romaine lettuces, crisphead lettuces, looseleaf lettuces, seed lettuces, onion, paprika, parsnip, parsley, pea, baking potatoes, boiling potatoes, frying potatoes, seed potatoes, pumpkin, radish, shallot, small radish, field/oil soybean, seed soybean, vegetable/garden soybean, spinach, beefsteak tomatoes, campari tomatoes, cherry tomatoes, paste-drying tomatoes, plum tomatoes, salad tomatoes, slicing/globe tomatoes, swede turnip and turnip.

More particularly, the plant may be selected from the group consisting of amaranth, canola, culinary barley, malting barley, livestock feed/silage barley, seed barley, buckwheat, livestock feed corn, ornamental corn, popping corn, seed corn, silage corn, sweet corn, starch corn, fonio, kamut, millet, culinary oats, livestock feed/silage oats, seed oats, quinoa, African rice, Australian rice, Caribbean rice, Far Eastern rice, Indian subcontinent rice, Middle Eastern rice, North American rice, seed rice, Southeast Asian rice, Spanish rice, wild rice, rye, sorghum, spelt, teff, triticale, durum wheat, spring wheat, spring spelt wheat, winter wheat and winter spelt wheat.

Another nonlimitative example of plant may include hemp seed. More particularly, the invention is particularly useful to control the total bacteria living on said hemp seed.

Other nonlimitative examples of plants may include roots such as potatoes, or cereals such as corn, rice, wheat, barley, sorghum, millet, oats, ryes, triticale, fonio, teff, buckwheat, quinoa, etc.

The aqueous solutions prepared with the powdered composition according to the invention may have many beneficial effects on growing plants including, but not limited to, controlling microbial pathogens; protecting the plant against microbial pathogens, promoting natural defense of the plant, providing oxygen to roots of the plant, providing essential nutrients to the plant.

According to a particularly preferred embodiment, the expression “controlling” includes, but is not limited to, preventing a microbial pathogen infection, inhibiting or slowing growth of microbial pathogen(s), killing, and/or eradicating the microbial pathogen(s), etc. The methods and compositions according to the invention may be used in both curative and preventive programs.

According to a particularly preferred embodiment, in some embodiments, the aqueous solution which is used for treating the plant tissue comprises about 20 ppm, or about 50 ppm, or about 75 ppm, or about 100 ppm, or about 200 ppm, or about 300 ppm, or about 400 ppm, or about 500 ppm, or about 750 ppm, or about 1000 ppm, or about 1500 ppm or about 2000 ppm of peracetic acid (PAA). The solution is preferably at pH 8.0±3.0, but depending on the particular uses in could be as low as pH 4±2.0 and as high as pH 9.5±2.0.

According to a particularly preferred embodiment, the present invention contemplates a powdered composition which is dissolved to obtain a diluted aqueous solution prior to its utilization in controlling plants microbial pathogens. For safety and economical reasons, in a preferred embodiment, the powdered composition would be marketed as a concentrate and the end user would dilute the concentrate with water to a use solution. The level of active components in the concentrate powdered composition and/or diluted solution will be dependent upon the intended dilution factor and desired activity in the use solution.

According to a particularly preferred embodiment, the aqueous solutions according to the invention can be applied to the plant tissue in a variety of techniques. For instance, the aqueous solution can be sprayed, painted, daubed, fogged, onto or into the plant, the plant hydroponic substrate, the agricultural earth (e.g. irrigation). The solution can be reapplied periodically as needed.

According to a particularly preferred embodiment, another aspect of the invention pertains to commercial packages or kits for using the compositions and carrying out the methods of the invention. Kits according to the invention may be used for preparing aqueous solutions for use in controlling microbial pathogens on a tissue of a growing plant.

According to a particularly preferred embodiment, an additional aspect of the invention related to kits. In one embodiment, the kit includes a container (e.g. a pouch, a tablet, a bucket, etc.) comprising a powdered composition as defined herein, and a user manual or instructions. A kit of the invention may further comprise one or more of the following elements: test strips for determining peracetic levels, test strips for determining hydrogen peroxide levels, test kits for determining peracetic acid levels.

According to a particularly preferred embodiment, the powdered compositions according to the invention would be marketed as a concentrate to be diluted by an end user. It is also conceivable according to the invention to provide the end user with separate containers comprising individually the active components of the powdered composition according to the invention. The end user will then mix himself the active components for achieving an intended dilution factor and a desired activity.

According to another particularly preferred embodiment of the invention, the said at least one systemic enhancer is selected from the group consisting of: at least one pesticide comprising a water soluble silicate salt; at least one biopesticide comprising a water soluble silicate salt; acibenzolar-S-methyl; silica/silicate; DL-α-amino-n-butyric acid (AABA); DL-β-amino-n-butyric acid (BABA); γ-amino-n-butyric acid (GABA); p-aminobenzoic acid (PABA); riboflavin; salicylic acid (SA); and Harpin protein (messenger).

According to another particularly preferred embodiment of the invention, the powdered composition defined hereinabove, may further comprise at least one surfactant. Preferably, the at least one surfactant is an anionic surfactant, a nonionic surfactant, a cationic surfactant or an amphoteric surfactant.

According to another particularly preferred embodiment of the invention, the powdered composition defined hereinabove, the at least one surfactant is
an anionic surfactant selected from the group consisting of carboxylates, sulfonates, petroleum sulfonates, alkylbenzenesulfonates, naphthalene sulphonates, olefin sulphonates, alkyl sulphates, sulphated natural oils, sulphated natural fats, sulphated esters, sulphated alkanolamides, sulphated alkanolamides, alkylphenols ethoxylated and alkylphenols sulphated; or
a non-ionic surfactant selected from the group consisting of ethoxylated aliphatic alcohol, polyoxyethylene surfactants, carboxylic esters, polyethylene glycol esters, anhydrosorbitol ester and its ethoxylated derivarives, glycol esters of fatty acids, carboxylic amides, monoalkanolamine condensates and polyoxyethylene fatty acid amides; or
a cationic surfactant selected from the group consisting of quarternary ammonium salts, amines with amide linkages, polyoxyethylene alkyl and alicyclic amines, 4-N,N,N′,N′-tetrakis substituted ethylenediamines and 5,2-alkyl-1-hydroxyethyl 2-imidazolines; or
an amphoteric surfactant selected from the group consisting of N-coco 3-aminopropionic acid and its sodium salt, N-tallow 3-iminodipropionate and its disodium salt, N-carboxymethyl N-dimethyl N-9 octadecenyl ammonium hydroxide, and N-cocoamidethyl N-hydroxyethylglycine and its sodium salt.

According to another particularly preferred embodiment of the invention, the powdered composition defined hereinabove, the at least one surfactant is an alpha olefin sulfonate, preferably a surfactant consisting of an alpha olefin sulfonate having from 12 to 18 carbon atoms.

According to another particularly preferred embodiment of the invention, the acetylating agent is an organic acid, preferably an organic acid containing at least one acyl group which is susceptible to perhydrolysis.

According to another particularly preferred embodiment of the invention, the acetylating agent is a N-acyl compound or a O-acyl compound containing an acyl radical R—CO— wherein R is an aliphatic group having from 5 to 18 carbon atoms, or an alkylaryl group having from 11 to 24 carbon atoms, with 5 to 18 carbon atoms in the alkyl chain. Preferably, R may be an aliphatic group having from 5 to 12 carbon atoms.

According to another particularly preferred embodiment of the invention, the acylating agent is tetraacetyl glycoluril (TAGU), tetraacetylethylendiamine (TAED), diacetyl dioxohexahydratriazine (DADHT), or mixtures thereof.

According to another particularly preferred embodiment of the invention, the acylating agent is acetylsalicylic acid or tetraacetylethylenediamine (TAED).

According to another particularly preferred embodiment of the invention, the method for controlling pathogens on a tissue of a growing plant having roots and leaves, said method comprising treating said growing plant with an aqueous solution obtained by admixing the water soluble mixture defined hereinabove or the composition defined hereinabove as an embodiment of the invention, the resulting aqueous solution comprising peracetic acid at a concentration and a pH which are not harmful for said plant tissue and at least one systemic enhancer.

According to another particularly preferred embodiment of the invention, the method for controlling pathogens on a tissue of a growing plant, as defined hereinabove, wherein said treatment is repeated according to a predetermined schedule, synergistic effect being observed once the systemic enhancer and the peracetic acid are respectively simultaneously present in and on the plant.

According to another particularly preferred embodiment of the invention, the method for controlling pathogens on a tissue of a growing plant, as defined hereinabove, wherein pathogens are selected from the group consisting of viruses, bacteria, fungus, yeasts and molds. Preferably, pathogens are bacteria, and more preferably Xanthomonas spp.

According to another particularly preferred embodiment of the invention, the method for controlling pathogens on a tissue of a growing plant, as defined hereinabove, wherein the aqueous solution comprises between about 20 ppm to about 2000 ppm of peracetic acid (PAA) and have a pH of 7.0±2.0, preferably 7.0±1.5 and more preferably 7.0±1.0.

According to another particularly preferred embodiment of the invention, the method for controlling pathogens on a tissue of a growing plant, as defined hereinabove, wherein the peracetic acid is generated in situ in the aqueous solution.

According to another particularly preferred embodiment of the invention, the method for controlling pathogens on a tissue of a growing plant, as defined hereinabove, wherein said aqueous solution is sprayed onto the leaves of the growing plant, and a substrate comprising roots of said growing plant, and wherein the at least one systemic enhancer is absorbed by leaves and the roots of the growing plant.

Those skilled in the art will recognize, or be able to ascertain using no more than routine experimentation, numerous equivalents to the invention defined in the present specification. Such equivalents are considered to be within the scope of said invention.

The invention is further illustrated by the following examples, which should not be construed as further limiting.

Additional aspects, advantages and features of the present invention will become more apparent upon reading of the following non-restrictive description of preferred embodiments which are exemplary and should not be interpreted as limiting the scope of the invention.

### EXAMPLES

### Example 1

### Effect of Copper Metal Ions on Peracetic Acid

### Protocol

Peracetic acid was generated by admixing with water a powdered product which is hereinafter called ATO CIDE. More particularly, 2 grams of the powdered product identified hereinafter under the name ATO CIDE was added and mixed for 10 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10 min, the peracetic acid concentration present in the solution was measured by Lamotte peracetic acid test kit (code 7191-01) and calculated to be 210 ppm.

Then, 100 mL of the above-mentioned solution of peracetic acid (i.e ATO CIDE solution) was mixed for 5 minutes with 0.1 g of a powdered product sold under the trademark PARASOL WG®. PARASOL WG® is a powdered product comprising 50% elemental copper as copper hydroxide.

### Results

3 hours after the addition of the PARASOL WG®, the peracetic acid was measured by Lamotte peracetic acid test kit and was found to be completely decomposed (0 ppm).

### Example 2

### Effect of Fertilizers Containing Metals Ions on Peracetic Acid

Peracetic acid was generated by admixing with water a powdered product called hereinafter under the name ATO CIDE. More particularly, 2 grams of ATO CIDE was added and mixed for 10 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10 min, the peracetic acid concentration present in the solution was measured by Lamotte peracetic acid test kit (code 7191-01) and calculated to be 210 ppm.

Then, a 100 mL of the above-mentioned solution of peracetic acid (i.e. ATO CIDE solution) was mixed for 5 minutes with 0.4 g of a powdered fertilizer sold under the trademark PRO-SOL®. PRO-SOL® is a 20-20-20 N-P-K fertilizer containing metal ions.

### Results

3 hours after the addition of the PRO-SOL®, the peracetic acid was measured by Lamotte peracetic acid test kit and was found to be decomposed (less than 15 ppm).

### Example 3

### Effects of Sequestering Agents on the Stability of ATO CIDE Mixed with Copper Metal Ions

The objective of this experiment is to improve the stability of ATO CIDE with copper metal ions by using a chelating agent PBTCA (phosphonobutanetricarboxylic acid).

### Protocol

Peracetic acid was generated by admixing with water a powdered product called ATO CIDE. More particularly, 2 grams of a powdered product sold under the trade name ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed for 5 minutes 0.2 mL of a complexing agent (PBTCA) until the sequestering agent was dissolved completely, and then 0.1 g of a powdered product sold under the trademark PARASOL WG® is added and dissolved with the resulting mixture. PARASOL WG® is a powdered product comprising 50% elemental copper as copper hydroxide.

### Results

3 hours after the addition of the PBTCA and the PARASOL WG®, the peracetic acid was measured by Lamotte peracetic acid test kit and was found to be only between 0 ppm-15 ppm.

### Example 4

### Effects of Sequestering Agents on the Stability of ATO CIDE Mixed with Copper Metal Ions

The objective of this experiment is to improve the stability of ATO CIDE with copper metal ions by using a chelating agent HEDPA (1-hydroxyethane(1,1-diylbiphosphonic acid)).

### Protocol

Peracetic acid was generated by admixing with water a powdered product called ATO CIDE. More particularly, 2 grams of a powdered product sold under the trade name ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 mL of HEDPA until the sequestering agent was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the HEDPA and the PARASOL WG®, the peracetic acid was measured by Lamotte peracetic acid test kit and was found to be only between 0 ppm-15 ppm.

### Example 5

### Effects of Sequestering Agents on the Stability of ATO CIDE Mixed with Copper Metal Ions

The objective of this experiment is to improve the stability of ATO CIDE with copper metal ions by using a chelating agent Na₄EDTA (ethylenediaminetetraacetic acid, tetrasodium salt).

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 mL of Na₄EDTA until the sequestering agent was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the Na₄EDTA and the PARASOL WG®, the peracetic acid was measured by Lamotte peracetic acid test kit and was found to be only between 0 ppm-15 ppm.

### Example 6

### Effects of Sequestering Agents on the Stability of ATO CIDE Mixed with Copper Metal Ions

The objective of this experiment is to improve the stability of ATO CIDE with copper metal ions by using a chelating agent NTA (nitrilotriacetic acid).

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 gram of NTA until the sequestering agent was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the NTA and the PARASOL WG®, the peracetic acid was measured by Lamotte peracetic acid test kit and was found to be only between 0 ppm-15 ppm.

### Example 7

### Effects of Citric Acid on the Stability of ATO CIDE Mixed with Copper Metal Ions

The objective of this experiment is to improve the stability of ATO CIDE with copper metal ions by using citric acid.

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 gram of powdered citric acid (food grade) until the sequestering agent was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the citric acid (food grade) and the PARASOL WG®, the peracetic acid was measured by Lamotte peracetic acid test kit and was found to be 15 ppm.

### Example 8

### Effects of Sulfamic Acid on the Stability of ATO CIDE Mixed with Copper Metal Ions

The objective of this experiment is to improve the stability of ATO CIDE with copper metal ions by using sulfamic acid.

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 gram of sulfamic acid (supplied by Univar) until the powdered sulfamic acid was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the sulfamic acid and the PARASOL WG®, the peracetic acid was measured by Lamotte peracetic acid test kit and was found to be still active (195 ppm).

### Example 9

### Effects of Phosphoric Acid on the Stability of ATO CIDE Mixed with Copper Metal Ions

The objective of this experiment is to improve the stability of ATO CIDE with copper metal ions by using phosphoric acid.

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 mL of phosphoric acid (85% v/v) until the powdered phosphoric acid was dissolved completely, and then 0.1 g of a powdered product sold under the trademark PARASOL WG® was mixed and dissolved with the resulting mixture. PARASOL WG® is a powdered product comprising 50% elemental copper as copper hydroxide.

### Results

3 hours after the addition of the phosphoric acid and the PARASOL WG®, the peracetic acid was measured by Lamotte peracetic acid test kit and was found to be still active (210 ppm).

### Example 10

### Effects of Phosphoric Acid on the Stability of ATO CIDE Mixed with PRO-SOL® Fertilizer

The objective of this experiment is to improve the stability of ATO CIDE with fertilizers containing metal ions by using phosphoric acid.

### Protocol

Peracetic acid was generated by admixing with water the powdered product called hereinafter under the name ATO CIDE. More particularly, 2 grams of ATO CIDE was added and mixed for 10-15 minutes with in 1 liter of water, to give a solution of 2 g/L ATO CIDE. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10-15 min, the peracetic acid concentration present in the solution was measured by Lamotte peracetic acid test kit (code 7191-01) and calculated to be 255 ppm.

Then, a 100 mL of the above-mentioned solution of peracetic acid (i.e ATO CIDE solution) was mixed with 0.2 mL of phosphoric acid (85%) until the powdered phosphoric acid was dissolved completely, and then 0.2 g of a fertilizer sold under the trademark PRO-SOL® 20-20-20 GS2. PRO-SOL® is a 20-20-20 fertilizer containing micro-essential elements and metal ions such as boron, copper, complexed iron, manganese, molybdenum, zinc, chloride (company Pro-Sol).

### Results

3 hours after the addition of the phosphoric acid and the PRO-SOL® fertilizer, the peracetic acid was measured by Lamotte peracetic acid test kit and was found to be still active (255 ppm).

Also, the above-mentioned protocol was repeated as follows. Peracetic acid was generated, according to another preferred embodiment of the invention, by admixing with water a powdered product called hereinafter under the name 18/18. More particularly, 2 grams of 18/18 was added and mixed for 10-15 minutes with 1 liter of water, to give a solution of 2 g/L 18/18. 18/18 is a powdered mixture consisting of:

| | |
|---|---|
| Coated sodium percarbonate | 40% w/w |
| TAED | 20% w/w |
| KASIL SS (potassium silicate) | 18% w/w |
| BIO-TERGE AS-90 (sodium C₁₄₋₁₆ olefin sulfonate) | 4% w/w |
| EDTA | 18% w/w |
| TOTAL: | 100% w/w. |

After 10-15 min, the peracetic acid concentration present in the 18/18 solution was measured by Lamotte peracetic acid test kit (code 7191-01) and calculated to be 255 ppm.

Then, a 100 mL of the above-mentioned solution of peracetic acid (i.e 18/18 solution) was mixed with 0.2 mL of phosphoric acid (85%) until the powdered phosphoric acid was dissolved completely, and then 0.2 g of a fertilizer sold under the trademark PRO-SOL® 20-20-20 GS2. PRO-SOL® is a 20-20-20 fertilizer containing micro-essential elements and metal ions such as boron, copper, complexed iron, manganese, molybdenum, zinc, chloride (company Pro-Sol).

### Results

3 hours after the addition of the phosphoric acid and the PRO-SOL® fertilizer, the peracetic acid was measured by Lamotte peracetic acid test kit and was found to be still active (255 ppm).

### Conclusion

Phosphoric acid solubilized copper hydroxide and prevented peracetic acid from being decomposed.

### Examples 11-a and 11-b

### Stability Improvement of Peracetic Acid and Hydrogen Peroxide by Using Sulfamic and Phosphoric Acid in the Presence of Copper Metal Ions

### Examples 11-a and 11-a′

### Protocol (Example 11-a)

Peracetic acid was generated by admixing with water the powdered product called ATO CIDE. More particularly, 8 grams of ATO CIDE was added and mixed for 10 minutes with in 4 liter of water. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10 min, the peracetic acid concentration present in the solution was measured by Lamotte peracetic acid test kit (code 7191-01) and calculated to be 210 ppm. This solution was called STOCK SOLUTION.

Then, 1 liter of the above-mentioned solution of peracetic acid (i.e. ATO CIDE solution) was mixed with 0.2 mL of phosphoric acid (85% v/v), and then 1 g of a powdered product sold under the trademark PARASOL WG® was mixed and dissolved with the resulting mixture. PARASOL WG® is a powdered product comprising 50% elemental copper as copper hydroxide.

### Results (Example 11-a)

2 hours after the addition of the phosphoric acid and the PARASOL WG®, the peracetic acid was measured by Lamotte peracetic acid test strip (code 3000) and found very active (>160 ppm).

### Protocol (Example 11-a′)

Also, the above-mentioned protocol was repeated as follows. Peracetic acid was generated, according to another preferred embodiment of the invention, by admixing with water the powdered product called hereinafter under the name 18/18. More particularly, 2 grams of 18/18 was added and mixed for 10-15 minutes with 1 liter of water, to give a solution of 2 g/L 18/18. 18/18 is a powdered mixture consisting of:

| | |
|---|---|
| Coated sodium percarbonate | 40% w/w |
| TAED | 20% w/w |
| KASIL SS (potassium silicate) | 18% w/w |
| BIO-TERGE AS-90 (sodium C₁₄₋₁₆ olefin sulfonate) | 4% w/w |
| EDTA | 18% w/w |
| TOTAL: | 100% w/w. |

After 10 min, the peracetic acid concentration present in the 18/18 solution was measured by Lamotte peracetic acid test kit (code 7191-01) and calculated to be 210 ppm. This solution was called STOCK SOLUTION.

Then, 1 liter of the above-mentioned solution of peracetic acid (i.e. 18/18 solution) was mixed with 0.2 mL of phosphoric acid (85% v/v), and then 1 g of a powdered product sold under the trademark PARASOL WG® was mixed and dissolved with the resulting mixture. PARASOL WG® is a powdered product comprising 50% elemental copper as copper hydroxide.

### Results (Example 11-a′)

2 hours after the addition of the phosphoric acid and the PARASOL WG®, the peracetic acid was measured by Lamotte peracetic acid test strip (code 3000) and found very active (>160 ppm).

### Conclusion (Examples 11-a and 11-a′)

Phosphoric acid solubilized copper hydroxide and prevented peracetic acid from being decomposed.

### Example 11-b

### Protocol (Example 11-b)

One liter of the STOCK SOLUTION of example 11-a was mixed with 2 g powdered sulfamic acid until the sulfamic acid was dissolved completely, and then 1 g of a powdered product sold under the trademark PARASOL WG® was mixed and dissolved with the resulting mixture. PARASOL WG® is a powdered product comprising 50% elemental copper as copper hydroxide.

### Results (Example 11-b)

2 hours after the addition of the sulfamic acid and the PARASOL WG®, the peracetic acid was measured by Lamotte peracetic acid test strip (code 3000) and found very active (>160 ppm).

### Conclusion 11-b

Sulfamic acid solubilized copper hydroxide and prevented peracetic acid from being decomposed.

### Examples 12-a, 12-b and 12-c

### Stability Improvement of Liquid Peracetic Acid and Hydrogen Peroxide Formulation by Using Sulfamic and Phosphoric Acid in the Presence of Copper Metal Ions

### Example 12-a

### Protocol (Example 12-a)

4 mL of ZEROTOL® (company BioSafe Systems) (EPA approved liquid peracetic acid and hydrogen peroxide) was added and mixed in 1 L water.

### Results (Example 12-a)

2 hours after the addition of the ZEROTOL®, the peracetic acid was measured by Lamotte peracetic acid test strip (code 3000) and found very active (>160 ppm).

### Example 12-b

### Protocol (Example 12-b)

4 mL of ZEROTOL® (EPA approved liquid peracetic acid and hydrogen peroxide) was added and mixed in 1 L water. Then 2 g of copper hydroxide were added to the resulting mixture.

### Results (Example 12-b)

2 hours after the addition of the ZEROTOL® and the copper hydroxide, the peracetic acid was measured by Lamotte peracetic acid test strip (code 3000) and found not very active (0 ppm). The peracetic acid was decomposed.

### Example 12-c

### Protocol (Example 12-c)

4 mL of ZEROTOL® (EPA approved Liquid peracetic acid and hydrogen peroxide) was added and mixed in 1 L water. Then 2 mL of phosphoric acid were added to the resulting mixture and mixed therein. Then, 2 g of copper hydroxide were added to the resulting mixture.

### Results (Example 12-c)

2 hours after the addition of the ZEROTOL®, the phosphoric acid and the copper hydroxide, the peracetic acid was measured by Lamotte peracetic acid test strip (code 3000) and found very active (>160 ppm).

### Conclusion of Examples 12-a, 12-b and 12-c

Copper metal ions destroyed peracetic acid contained in liquid formulations. Acids (i.e. phosphoric acid) prevented the decomposition of peracetic acid by metal ions.

### Example 13

### Effects of Various Concentrations of an Acid Complexing Agent (Boric Acid) on the Stability of ATO CIDE or 18/18 Mixed with Copper Based Compounds

The objective of this experiment is to study the optimal concentrations of boric acid which can stabilize ATO CIDE or 18/18 with metal ions.

### Protocol

Peracetic acid was generated by admixing with water the powdered product called hereinafter under the name ATO CIDE. More particularly, 8 grams of ATO CIDE was added and mixed for 5-10 minutes with in 4 liter of water. ATO CIDE is a powdered mixture consisting of:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 (sodium C₁₄₋₁₆ olefin sulfonate) | 4% w/w |
| EDTA | 1% w/w |
| TOTAL: | 100% w/w. |

After 10 min, the peracetic acid concentration present in the solution was measured by Lamotte peracetic acid test kit (code 7191-01) and calculated to be 180 ppm. Then mixtures were prepared as per below table:

| Mixture #1 | Mixture #2 | Mixture #3 |
|---|---|---|
| 1 L Ato cide | 1 L Ato cide | 1 L Ato cide |
| | 2.5 g Boric acid | 2.5 g Boric acid |
| | | 1 g Copper |
| Time 10 min | Time 10 min | Time 10 min |
| 180 ppm PAA | 180 ppm PAA, | 180 ppm PAA, |
| | then 2 g boric acid | then 2 g boric acid were added. |
| | were added. | Finally 1 g copper hydroxide |
| | | was added. |
| After 48 hrs | After 48 hrs | After 48 hrs |
| 60 ppm PAA | 160 ppm PAA | 15 ppm PAA |

Also, the above-mentioned protocol was repeated as follows. Peracetic acid was generated by admixing with water the powdered product called hereinafter under the name 18/18. More particularly, 8 grams of 18/18 was added and mixed for 5-10 minutes with in 4 liter of water. 18/18 is a powdered mixture consisting of:

| | |
|---|---|
| Coated sodium percarbonate | 40% w/w |
| TAED | 20% w/w |
| KASIL SS (potassium silicate) | 18% w/w |
| BIO-TERGE AS-90 (sodium C₁₄₋₁₆ olefin sulfonate) | 4% w/w |
| EDTA | 18% w/w |
| TOTAL: | 100% w/w. |

After 10 min, the peracetic acid concentration present in the solution was measured by Lamotte peracetic acid test kit (code 7191-01) and calculated to be 180 ppm. Then mixtures were prepared as per below table:

| Mixture #1 | Mixture #2 | Mixture #3 |
|---|---|---|
| 1 L 18/18 | 1 L 18/18 | 1 L 18/18 |
| | 2.5 g Boric acid | 2.5 g Boric acid |
| | | 1 g Copper |
| Time 10 min | Time 10 min | Time 10 min |
| 180 ppm PAA | 180 ppm PAA, | 180 ppm PAA, |
| | then 2 g boric acid | then 2 g boric acid were added. |
| | were added. | Finally 1 g copper hydroxide |
| | | was added. |
| After 48 hrs | After 48 hrs | After 48 hrs |
| 60 ppm PAA | 160 ppm PAA | 15 ppm PAA |

### Conclusions

1) Boric acid stabilizes PERACETIC ACID in solution for a longer period of time.
2) Boric acid is not as good as phosphoric acid in chelating copper hydroxide.

### Example 14

### Experiments 14: Effects of Various Concentrations of Acids and Complexing Agents on the Stability of Peracetic Acid Mixed with Copper Based Compounds

The objective of this experiment is to study the optimal concentrations of complexing agents which can stabilize a peracetic acid liquid formulation with metal ions.

### Protocol

Solutions of 4 mL PERCID® were made and mixed with 1 L water for 5 to 10 minutes. PERCID® is a liquid sanitizer containing around 5% active peracetic acid and more than 20% hydrogen peroxide (company Atomes F.D. Inc).

After 10 min, the peracetic acid concentration present in the solution was measured by Lamotte peracetic acid test kit (code 7191-01) and calculated to be 225 ppm. Then mixtures #1 to #5 were prepared as per below table:

| Mixture #1 | Mixture #2 | Mixture #3 | Mixture #4 | Mixture #5 |
|---|---|---|---|---|
| 4 mL | 4 mL | 4 mL | 4 mL | 4 mL |
| PERCID ®/ | PERCID ®/ | PERCID ®/ | PERCID ®/ | PERCID ®/ |
| L | L | L | L | L |
| | 0.5 g copper | 4 mL | 4 mL | 7 mL sulfamic |
| | | phosphoric | phosphoric | 2 g copper |
| | | | 2 g copper | |
| Time 0 hrs | Time 0 hrs | Time 0 hrs | Time 0 hrs | Time 0 hrs |
| pH 4.1 | pH 4.5 | pH 2.2 | pH 2.8 | pH 2.3 |
| 225 ppm | | | | |
| PAA | | | | |
| 2000 ppm | | | | |
| H₂O₂ | | | | |
| Time 24 hrs | Time 4 hrs | Time 4 hrs | Time 4 hrs | Time 4 hrs |
| 225 ppm | Copper test | 250 ppm | 255 ppm | 180 ppm |
| PAA | strip: active | PAA | PAA | PAA |
| After 48 hrs | <15 ppm | After 24 hrs | Copper test | Copper test |
| 150 ppm | PAA | 165 ppm | strip: active | strip: active |
| PAA | Time 24 hrs | PAA | After 24 hrs | After 24 hrs |
| | 0 ppm PAA | 2200 ppm | 210 ppm | 150 ppm |
| | 350 ppm | H₂O₂ | PAA | PAA |
| | H₂O₂ | After 48 hrs | 2250 ppm | 1750 ppm |
| | Time 48 hrs | 90 ppm | H₂O₂ | H₂O₂ |
| | 0 ppm | PAA | After 48 hrs | After 48 hrs |
| | PAA | | 60 ppm | 60 ppm |
| | | | PAA | PAA |

### Conclusion

PERCID® (liquid peracetic acid+H₂O₂) was also stabilized with copper metal ions by the presence of either sulfamic or phosphoric acid. Again, once copper is mixed with peracetic-H₂O₂-sulfamic or phosphoric), the peracetic is stable for a longer period of time.

### Example 15

### Effects of Various Concentrations of Phosphorous Acid Complexing Agent on the Stability of Peracetic Acid Mixed with Copper Based Compounds

The objective of this experiment is to study the optimal concentrations of phosphorous acid which can stabilize peracetic acid either with metal ions or without metal ions.

### Protocol

Mixtures were prepared at room temperature (around 20° C.) as per the following table:

| | Time | | | | | |
|---|---|---|---|---|---|---|
| Treatments | zero | 24 hrs | 48 hrs | 120 hrs | 148 hrs | 172 hrs |
| Trt 1: | pH | pH | pH | pH | pH | pH |
| Phosphorous | (0.1%): | (0.1%): | (0.1%): | (0.1%): | (0.1%): | (0.1%): |
| acid (1 g/L) | 2.80 | 2.53 | 2.80 | 2.90 | 2.85 | 2.80 |
| Trt 2: | After 45 min: | pH | pH | pH | pH | pH |
| Ato Cide | 315 ppm | (0.2%) | (0.2%) | (0.2%) | (0.2%) | (0.2%) |
| (2 g/L) | PAA | 8.8 | 9.0 | 9.5 | 9.0 | 8.8 |
| | | 270 ppm | 210 ppm | 105 ppm | 75 ppm | 45 ppm |
| | | PAA | PAA | PAA | PAA | PAA |
| Trt 3: | After 45 min: | pH | pH 5.80 | pH 6.0 | pH 6.0 | pH 5.9 |
| Ato Cide | 300 ppm | 5.80 | 285 ppm | 240 ppm | 225 ppm | 225 ppm |
| 2 g/L + | PAA | 300 ppm | PAA | PAA | PAA | PAA |
| phosphorous | then 1 g/L | PAA | | | | |
| acid 1 g/L | phosphorous | | | | | |
| | was | | | | | |
| | added | | | | | |
| | pH 5.5 | | | | | |
| Trt 4: | After 45 min: | pH 2.9 | pH 2.9 | pH 2.9 | pH 2.9 | pH 2.9 |
| Ato Cide | 330 ppm | 330 ppm | 300 ppm | 240 ppm | 225 ppm | 225 ppm |
| 2 g/L + | PAA | PAA | PAA | PAA | PAA | PAA |
| phosphorous | then | | | | | |
| acid 2.5 g/L | 2.5 g/L | | | | | |
| | phosphorous | | | | | |
| | was | | | | | |
| | added | | | | | |
| | pH 2.6 | | | | | |
| Trt 5: | After 45 min: | pH | pH 2.95 | pH 2.90 | pH 2.95 | pH 2.9 |
| Ato Cide | 250 ppm | 2.95 | 180 ppm | 165 ppm | 150 ppm | 135 ppm |
| 2 g/L + | PAA | 225 ppm | PAA | PAA | PAA | PAA |
| Phosphorous | then 2.5 g/L | PAA | | | | |
| acid 2.5 g/L + | phosphorous | | | | | |
| copper | was | | | | | |
| 0.5 g/L | added, | | | | | |
| | then 0.5 g | | | | | |
| | copper | | | | | |
| | was | | | | | |
| | added | | | | | |
| | pH 2.94 | | | | | |
| Trt 6: | pH 7 | pH 7 | pH 7 | pH 7 | pH 7 | pH 7 |
| Copper: 2.0 g/L | 0 ppm | 0 ppm | 0 ppm | 0 ppm | 0 ppm | 0 ppm |
| | PAA | PAA | PAA | PAA | PAA | PAA |
| Trt 7: | pH 5 | pH 5 | pH 5 | pH 5 | pH 5 | pH 5 |
| Phosphorous | 0 ppm | 0 ppm | 0 ppm | 0 ppm | 0 ppm | 0 ppm |
| acid 2.0 g/L + | PAA | PAA | PAA | PAA | PAA | PAA |
| Copper | | | | | | |
| 0.5 g/L | | | | | | |

### Conclusions

ATO CIDE (2 g/L) generates peracetic acid (>200 ppm) within less than 1 hour but decomposes over time.

The presence of 1 g/L Phosphorous acid stabilizes the peracetic acid very well. After 172 hours, the sample containing phosphorous acid has 225 ppm PAA whereas the sample with ATO CIDE alone has only 45 ppm.

The sample ATO CIDE+PHOSPHOROUS has 5 times the peracetic acid concentration.

The addition of 1 g/L phosphorous dropped the pH to near-neutral levels.
The addition of 2.5 g/L phosphorous also stabilizes the peracetic acid concentration.
The addition of 2.5 g/L phosphorous acid also complexed well the copper hydroxide and solubilized it in the solution. It also protected the peracetic acid from being decomposed by copper. (TRT 5).
TRT 5: ATO CIDE 2 G/L+PHOSPHOROUS 2.5 G/L+COPPER 0.5 G/L had 135 ppm PAA after 172 hours. Whereas the sample of ATO CIDE 2 G/L alone had only 45 ppm. (3 times more peracetic with the complex). Thus, phosphorous is stabilizing well the peracetic acid for a longer period of time and is preventing the decomposition effect of peracetic acid by copper hydroxide.

### Example 16

### Comparative Tests Illustrating the Improved Efficiency of Stabilized Composition in the Treatment of Strawberry Against Xanthomonas fragariae (Bacterial Angular Leaf Spot)

### Protocol of the Experiment

### The Setup of the Experiment.

At an outdoor test plot in Dover, Fla. (United States), a subset of an existing crop of mature fruiting strawberry plants was treated either by hand spray or airblast in late autumn 2012 using the following products or product combinations:

### The Treatments.

1. Untreated check.
2. 18/18 @ 3 lbs/ac hand sprayed
3. 18/18 @ 13.6 g/gal+Complexing agent @ 9.5 g/gal+Copper @ 1.9 g/gal
   18/18: a powdered mixture consisting of:

| | |
|---|---|
| Coated sodium percarbonate | 40% w/w |
| TAED | 20% w/w |
| KASIL SS (potassium silicate) | 18% w/w |
| BIO-TERGE AS-90 (sodium C₁₄₋₁₆ olefin sulfonate) | 4% w/w |
| EDTA | 18% w/w |
| TOTAL: | 100% w/w. |

Complexing agent: phosphorous acid crystalline.
Copper: a commercial product containing 54% by weight of copper hydroxide, equivalent to 35% elemental copper by weight.

A completely randomized block design was used for the above treatments. Plants were inoculated with angular leaf spot bacteria. Disease severities were evaluated five times bi-weekly between mid-December 2012 and mid-February 2013. Disease severities were rated according to AUDPC or Area Under the Disease Progress Curve. In AUDPC, the lower the numerical value, the better the disease control.

### The Results—Final Ratings.

| Treatment | Disease severity | AUDPC |
|---|---|---|
| 2 | 3.125 | 59.900 |
| 3 | 0.513 | 6.338 |

### The Conclusions.

The lowest disease severity (DS) both in terms of absolute value and AUDPC (i.e., the strongest disease control) was realised using treatment 13, namely, the 3-way combination of 18/18, complexing agent and copper. An unexpected result here is that the degree of disease control as measured by AUDPC and disease severity reduction were far greater than the expected DS reduction relative to the observed DS achieved by 18/18 alone. Moreover, this result was statistically significant. The other 2 components in the 3-way combination, namely, phosphorous acid (complexing agent) and copper, could not be split out here since individually they are phytotoxic to strawberry.

### Example 17

### Comparative Tests Illustrating the Improved Efficiency of Stabilized Composition in the Treatment of Rice

### Protocol of the Experiment

### The Setup of the Experiment.

Near Baton Rouge, La. (United States), a 64 ft² test field plot was drill seeded in mid-April with 100 lbs./ac of CL151 rice, a variety known to be susceptible to panicle blight. One month later the plot was fertilised, then flooded 1 month after fertilisation. By mid-July, the plot had been drained and re-flooded. Maintenance herbicides and insecticides were applied twice in the month of June.

### The Treatments.

1. Untreated check.
3. AN 77V2 @ 1 lb./ac.
7. AN 77V2 @ 1 lb./ac+complexing agent (phosphorous acid) @ 0.5 lb./ac.
9. Complexing agent (phosphorous acid) @ 0.5 lb./ac.
10. AN 77V2 @ 6 g/L (1 lbs./acre)+complexing agent (phosphorous acid) @ 3 g/L (0.5 lbs./ac.)+Kocide 2000 @ 1 g/L (0.166 lbs./ac.)=Total 1.66 lbs./ac.
12. Kocide 2000 @ 1 g/L (0.166 lbs./ac.).
   Kocide 2000: A commercial product of DuPont containing 54% by weight of copper hydroxide, equivalent to 35% elemental copper by weight.
   AN77V2: A product known as Ato Cide and having the following formulation before dilution in water.

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 | 4% w/w |
| EDTA | 1% w/w. |

A completely randomized block design was used for the above treatments. Plants were inoculated twice, just before mid-July, between the pre-heading and heading stages. Treatments were applied to leaves by hand sprayer weekly starting the 2^{nd} week of July, for a total of 4 applications. Disease severities were rated according to the Horsfall-Barratt (H-B) scale (see below) twice during the last week of July. Crops were harvested by mid-August.

| H-B Scale rating | % infected leaf surface |
|---|---|
| 0 | 0 |
| 1 | 0-3 |
| 2 | 3-6 |
| 3 | 6-12 |
| 4 | 12-25 |
| 5 | 25-50 |
| 6 | 50-75 |
| 7 | 75-87 |
| 8 | 87-94 |
| 9 | 94-97 |
| 10 | 97-100 |
| 11 | 100 |

In addition, disease severities were converted into AUDPC units, where AUDPC=area under the disease progress curve. The smaller the number, the lower the disease severity. Finally, % AUDPC reductions relative to the untreated check were calculated and tabulated.

### The Results—Final Ratings.

| Treatment | H-B | % infection | AUDPC | % reduction* |
|---|---|---|---|---|
| 1 | 7.39 | 80 | 21.75 | 0 |
| 3 | 5.96 | 49 | 17.46 | −19.7 |
| 7 | 6.07 | 52 | 17.84 | −18 |
| 9 | 5.64 | 40 | 16.29 | −25.1 |
| 10 | 4 | 12 | 11.63 | −46.5 |
| 12 | 5.5 | 37 | 16.13 | −25.8 |

*(in AUDPC relative to the untreated check.)

### The Conclusions.

Treatment 10, consisting of mixtures of AN77V2, Complexing agent (phosphorous acid) and copper hydroxide, were the most effective of all products and product combinations tested at reducing panicle blight severity relative to untreated checks, as measured both by the Horsfall-Barratt scale and AUDPC. Moreover, unlike all other treatments, these disease reductions were statistically significant. This illustrates that the improved stability of peracetic acid contributes to improve further the synergy between constitutive ingredient of AN77V2, and therefore the efficacy the mixtures used in treatment 10.

### Example 18

### Comparative Tests Illustrating the Improved Efficiency of Stabilized Composition in the Treatment of Rice

### Stability of TiO2 with ATO CIDE

### Protocol of the Experiment

ATO CIDE is a powdered product having before dilution in water the following formulation:

| | |
|---|---|
| Coated sodium percarbonate | 50% w/w |
| TAED | 20% w/w |
| KASIL SS (potassium silicate) | 10% w/w |
| Citric acid | 15% w/w |
| BIO-TERGE AS-90 | 4% w/w |
| EDTA | 1% w/w. |

In order to prepare another composition according to the invention, the amount of EDTA of the powdered composition of the ATO CIDE formulation has been modified as follows:

### Ingredients:

| | |
|---|---|
| coated sodium percarbonate | 40% w/w; |
| TAED | 20% w/w; |
| EDTA acid | 18% w/w; |
| potassium silicate | 18% w/w; |
| BIO-TERGE AS-90 | 4% w/w; |
| Total: | 100% w/w; |

Then 3.6 g of above formula was mixed with 1 L of water, stirring for at least 10 minutes. Then 3 g/L titanium dioxide were added. Thereafter, more than 150 ppm of peracetic acid could be detected after 3 hours.

### CONCLUSION

The higher amount of EDTA acid allows to form a complex with titanium dioxide and thus prevents the accelerated destruction of peracetic acid. Thus the extra amount of EDTA acid forms a complex with titanium dioxide (TiO₂) and therefore contributes to the improved stability and efficiency of the peracetic acid composition.

Also the composition obtained hereinabove was used in a tomato field at a concentration of 3 lbs/acre and sprayed every 5+/−1 days. In another treatment, an extra 1 g/L of titanium dioxide was added to the formula.

The improved composition comprising TiO₂ and an extra amount of EDTA acid, as prepared hereinabove, showed that in terms of the AUDPC reduction there was a 10% improvement in the control of disease due to Xanthomonas.

It is understood that the examples and embodiments described herein are for illustrative purposes only and that various modifications or changes in light thereof will be suggested to persons skilled in the art and are to be included within the present invention.

1.-237. (canceled)

238. A composition comprising:
from 1 to 10000 ppm of an oxidizer which is peracetic acid obtained in situ by dissolving in water a powdered composition of 30-70% w/w of a solid hydrogen peroxide precursor, 5-40% w/w a pH adjusting agent, 5-40% w/w of an acetylating agent, and optionally at least one surfactant,
from 0.01 to 10 g/L of a compound defining a precursor of a metal cation comprising an element selected from the group consisting of Ag, Cu, Mn, Ti and Zn;
from 0.1 to 10 g/L of an acid selected from the group consisting of inorganic acids and organic acids; and
optionally at least one excipient, additive and/or adjuvant, said excipient including water to form an aqueous solution;
to stabilize said oxidizer for 1 to 48 hours at room temperature.

239. The composition of claim 238, wherein the hydrogen peroxide precursor is a sodium percarbonate, the pH adjusting agent is citric acid or ethylenediaminetetraacetic (EDTA) acid, the acetylating agent is tetraacetylethylenediamine (TAED) and the precursor of the metal cation is titanium dioxide or is a compound precursor of silver ions or oxysilver ions.

240. The composition of claim 239, wherein the precursor of the metal cation is copper hydroxide, copper oxide, copper oxychloride, copper sulphate, copper phosphonate, copper octanoate, copper soap, copper ammonium complex, or a mixture of copper oxychloride and copper hydroxide.

241. The composition of claim 240, wherein it further comprises a SAR inducer which is a water soluble silicate salt.

242. A powdered composition which is a dry, water soluble mixture comprising:
(i) about 30-90% w/w of a peracetic acid precursor comprising:
(i)-a) about 30-60% w/w of a solid hydrogen peroxide precursor,
(i)-b) about 10-40% w/w a pH adjusting agent,
(i)-c) about 10-40% w/w of an acetylating agent; and
(ii) optionally at least one surfactant;
(iii) about 0.01-5% w/w of the compound defining a precursor of a metal cation comprising an element selected from the group consisting of Ag, Cu, Mn, Ti and Zn, and
(iv) about 0.01-5% w/w of the acid selected from the group consisting of inorganic acids and organic acids;
(v) optionally at least one excipient, additive and/or adjuvant;
wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

243. The powdered composition of claim 242, wherein the hydrogen peroxide precursor is a sodium percarbonate, the pH adjusting agent is citric acid or ethylenediaminetetraacetic (EDTA) acid, the acetylating agent is tetraacetylethylenediamine (TAED) and compound defining the precursor of the metal cation is titanium dioxide or a compound precursor of silver ions or oxysilver ions.

244. The powdered composition of claim 243, wherein the precursor of the metal cation is copper hydroxide, copper oxide, copper oxychloride, copper sulphate, copper phosphonate, copper octanoate, copper soap, copper ammonium complex, or a mixture of copper oxychloride and copper hydroxide.

245. The powdered composition of claim 243, wherein it further comprises a SAR inducer which is a water soluble silicate salt defining the SAR inducer.

246. A pesticide composition comprising:
from 1 to 10000 ppm of an oxidizer which is peracetic acid obtained in situ by dissolving in water a powdered composition of 30-70% w/w of a solid hydrogen peroxide precursor, 5-40% w/w a pH adjusting agent, 5-40% w/w of an acetylating agent, and optionally at least one surfactant,
from 0.01 to 10 g/L of a compound defining a precursor of a metal cation comprising an element selected from the group consisting of Ag, Cu, Mn, Ti and Zn;
from 0.1 to 10 g/L of an acid selected from the group consisting of inorganic acids and organic acids; and
optionally at least one excipient, additive and/or adjuvant, said excipient including water to form an aqueous solution;
to stabilize said oxidizer for 1 to 48 hours at room temperature, said metal cation or acid optionally further having bactericidal and/or fungicidal properties.

247. The pesticide composition of claim 246, wherein the hydrogen peroxide precursor is a sodium percarbonate, the pH adjusting agent is citric acid or ethylenediaminetetraacetic (EDTA) acid, the acetylating agent is tetraacetylethylenediamine (TAED) and the precursor of the metal cation is titanium dioxide or a compound which is precursor of silver ions or oxysilver ions.

248. The pesticide composition of claim 247, wherein the said compound defining a precursor of a metal cation is copper hydroxide, copper oxide, copper oxychloride, copper sulphate, copper phosphonate, copper octanoate, copper soap, copper ammonium complex, or a mixture of copper oxychloride and copper hydroxide.

249. The pesticide composition of claim 247, wherein it further comprises a SAR inducer which is a a water soluble silicate salt defining the SAR inducer.

250. The pesticide composition of claim 247, wherein said composition is a bactericide and/or a fungicide.

251. A powdered pesticide composition which is a dry, water soluble mixture comprising:
(i) about 30-90% w/w of a peracetic acid precursor comprising:
(i)-a) about 30-60% w/w of a solid hydrogen peroxide precursor,
(i)-b) about 10-40% w/w a pH adjusting agent,
(i)-c) about 10-40% w/w of an acetylating agent; and
(ii) optionally at least one surfactant;
(iii) about 0.01-5% w/w of the compound defining a precursor of a metal cation comprising an element selected from the group consisting of Ag, Cu, Mn, Ti and Zn, and
(iv) about 0.01-5% w/w of the acid selected from the group consisting of inorganic acids and organic acids;
(v) optionally at least one excipient, additive and/or adjuvant;
wherein (i)-a), (i)-b) and (i)-c) represent the peracetic acid precursor; and wherein when 2 g of said dry, water soluble mixture of (i)-a), (i)-b) and (i)-c) is admixed with 1000 g of water, about 100 to 250 ppm of peracetic acid (PAA) are generated in situ at pH 8.0±3, and wherein the ingredients (iii) and (iv) stabilize the peracetic acid.

252. The powdered pesticide composition of claim 251, wherein the hydrogen peroxide precursor is a sodium percarbonate, the pH adjusting agent is citric acid or ethylenediaminetetraacetic (EDTA) acid, the acetylating agent is tetraacetylethylenediamine (TAED) and the precursor of the metal cation is titanium dioxide or a compound which is a precursor of silver ions or oxysilver ions.

253. The powdered pesticide composition of claim 252, wherein the precursor of the metal cation is copper hydroxide, copper oxide, copper oxychloride, copper sulphate, copper phosphonate, copper octanoate, copper soap, copper ammonium complex, or a mixture of copper oxychloride and copper hydroxide.

254. The powdered pesticide composition of claim 252, wherein it further comprises a SAR inducer which is a water soluble silicate salt.

255. The powdered pesticide composition of claim 252, wherein said composition is a bactericide and/or a fungicide.

256. A method for improving the stability and/or efficiency of an oxidizer which is peracetic acid obtained in situ by dissolving in water a powdered composition of 30-70% w/w of a solid hydrogen peroxide precursor, 5-40% w/w a pH adjusting agent, 5-40% w/w of an acetylating agent, and optionally at least one surfactant, present in at least one excipient including water and in an amount of from 10-5000 mg/L; for 1 to 48 hours at room temperature, said method comprising a step of admixing with said excipient including water:
from 0.01 to 10 g/L of a precursor of a metal cation comprising an element selected from the group consisting of Ag, Cu, Mn, Ti and Zn;
from 0.1 to 10 g/L of an acid selected from the group consisting of inorganic acids and organic acids, and
optionally at least one additive and/or adjuvant, said excipient including water to form the aqueous solution.

257. The method claim 256, wherein the hydrogen peroxide precursor is a sodium percarbonate, the pH adjusting agent is citric acid or ethylenediaminetetraacetic (EDTA) acid, the acetylating agent is tetraacetylethylenediamine (TAED) and the precursor of the metal cation is titanium dioxide or a compound which is precursor of silver ions or oxysilver ions.

258. The method of claim 257, wherein the precursor of the metal cation is copper hydroxide, copper oxide, copper sulphate, copper phosphonate, copper octanoate, copper soap, copper ammonium complex, or a mixture of copper oxychloride and copper hydroxide.

259. The method of claim 257 wherein the precursor of a metal cation, the acid and the optionally at least one excipient, additive and/or adjuvant, are all agriculturally acceptable.

260. A method for the treatment of a surface of a tissue a growing plant, in order to control pathogens thereupon, said method comprising at least one step of applying to said surface of said tissue of the growing plant, a composition as defined in claim 238.

261. A method for the treatment of a surface, preferably of a tissue of a growing plant, in order to control pathogens thereupon, said method comprising at least one step of applying to said surface of said tissue of the growing plant, an aqueous composition prepared from a powdered composition as defined in claim 242.

262. A method for the treatment of a surface of a tissue of a growing plant, in order to control pests thereupon, said method comprising at least one step of applying to said surface of said tissue of the growing plant, a pesticide composition as defined in claim 246.

263. The method of claim 262 for the treatment of Xanthomonas on strawberry plant or for the treatment of Burholdaria on rice plant.

264. A kit for carrying out the method of claim 256, wherein said kit comprises in distinct containers:
the oxidizer which is peracetic acid obtained in situ by dissolving in water a powdered composition of 30-70% w/w of a solid hydrogen peroxide precursor, 5-40% w/w a pH adjusting agent, 5-40% w/w of an acetylating agent, and optionally at least one surfactant;
the compound defining the precursor of the metal cation comprising the element selected from the group consisting of Ag, Cu, Mn, Ti and Zn;
the acid selected from the group consisting of inorganic acids and organic,
optionally the at least one excipient including water, additive and/or adjuvant; and
a notice of instruction for dilution in the at least one excipient including water.

265. A kit for carrying out the method of claim 260, wherein said kit comprises in distinct containers:
a composition as defined in claim 238; and
the notice of instruction for dilution in excipient.

266. A kit for carrying out the method of claim 261, wherein said kit comprises in distinct containers:
a powdered composition as defined in claim 242; and
the notice of instruction for dilution in water.

267. A kit for carrying out the method of claim 262, wherein said kit comprises in distinct containers:
the pesticide composition as defined in claim 246; and
a notice of instruction for dilution in an excipient.
